(19) United States
(12) Patent Application Publication
(10) Pub. No.: US 2026/0084293 A1
(43) Pub. Date: Mar. 26, 2026

(54) FLOWCELL TRANSFER DEVICE, STATION LAYOUT DEVICE, AND SEQUENCING SYSTEM

(71) Applicant: GENEMIND BIOSCIENCES COMPANY LIMITED, Shenzhen (CN)

(72) Inventors: Wusheng LI, Shenzhen (CN); Guangming WANG, Shenzhen (CN)

(73) Assignee: GENEMIND BIOSCIENCES COMPANY LIMITED, Shenzhen (CN)

(21) Appl. No.: 19/326,691

(22) Filed: Sep. 11, 2025

(30) Foreign Application Priority Data
Sep. 26, 2024 (CN) 202411357119.4
Sep. 26, 2024 (CN) 202422361232.1

(51) Int. Cl. B25J 9/10; B25J 15/02; B25J 17/02

(52) U.S. Cl. CPC B25J 9/109; B25J 9/104; B25J 15/0253; B25J 17/0241

(57) ABSTRACT

The present application discloses a flowcell transfer device, a station layout device, and a sequencing system. The flowcell transfer device includes: a frame; a multi-dimensional motion mechanism arranged on the frame; and a flowcell gripping mechanism arranged on the multi-dimensional motion mechanism. The flowcell gripping mechanism includes: a first gripper driving member arranged on the multi-dimensional motion mechanism; and a first gripper connected to the first gripper driving member, where the first gripper includes oppositely arranged first jaw and second jaw, and driven by the first gripper driving member, the first jaw and the second jaw move toward or away from each other to grip or place the flowcell. The flowcell transfer device enables sequencing of multiple flowcells at multiple stations, which can effectively improve sequencing efficiency. The flowcell gripping mechanism can reliably grip or place the flowcell, and no additional design is required for the flowcell. The structure is simple, and the cost is low.

### CROSS-REFERENCE TO RELATED APPLICATIONS

This application claims priority to the Chinese Patent Application No. 202411357119.4, filed on Sep. 26, 2024, and the Chinese Patent Application No. 202422361232.1, filed on Sep. 26, 2024, the contents of each of which are hereby incorporated by reference.

### TECHNICAL FIELD

The present disclosure relates to the technical field of biological analysis, and in particular, to a flowcell transfer device, a station layout device, and a sequencing system.

### BACKGROUND OF THE INVENTION

The subject matter discussed in this section should not be regarded as prior art merely as a result of its mention in this section. Similarly, technical problems mentioned in this section or associated with the subject matter provided as background should not be considered as having been previously recognized in the prior art.

The throughput sequencer, as an essential component of whole-genome sequencing for humans, plays a crucial role. At present, to improve sequencing efficiency, some types of sequencers are provided with a plurality of stations. By means of a driving mechanism, the sequencing flowcell circulates among the various stations, enabling sequencing of multiple flowcells at multiple stations. In this type of sequencer, the driving mechanism adopts a single-rod support structure, and the sequencing flowcell is arranged on a carrier structure. The single-rod support structure cooperates with the carrier structure, such that at one station, the sequencing flowcell is lifted, and after the sequencing flowcell is moved to another station, the single-rod support structure disengages from the carrier structure, thereby placing the sequencing flowcell at the other station. Since the supporting force provided by the single-rod support structure is unreliable, there is a risk of the carrier structure slipping, that is, there is a risk of the sequencing flowcell slipping. Moreover, a separate carrier structure needs to be provided, resulting in a relatively complex structure and increased cost.

### SUMMARY

To address at least one of the above-mentioned technical problems to at least some extent or to provide a practical commercial means, embodiments of the present disclosure provide a flowcell transfer device, a station layout device, and a sequencing system.

A flowcell transfer device according to the embodiments of the present disclosure is used in a sequencing system. The flowcell transfer device includes:
a frame;
a multi-dimensional motion mechanism arranged on the frame; and
a flowcell gripping mechanism arranged on the multi-dimensional motion mechanism, where the multi-dimensional motion mechanism is capable of driving the flowcell gripping mechanism to move so as to achieve multi-dimensional motion, such that the flowcell gripping mechanism is capable of gripping a flowcell at any station and placing the flowcell at any other station.

The flowcell gripping mechanism includes:
a first gripper driving member arranged on the multi-dimensional motion mechanism;
and

a first gripper connected to the first gripper driving member, where the first gripper includes oppositely arranged first jaw and second jaw, and driven by the first gripper driving member, the first jaw and the second jaw move toward or away from each other to grip or place the flowcell.

In the flowcell transfer device provided according to the embodiments of the present disclosure, the multi-dimensional motion mechanism drives the flowcell gripping mechanism to move so as to achieve multi-dimensional motion, such that the flowcell gripping mechanism is capable of gripping a flowcell at any station and placing the flowcell at any other station. This achieves sequencing of multiple flowcells at multiple stations and effectively improves sequencing efficiency. The flowcell gripping mechanism adopts a mode in which the first jaw and the second jaw cooperate. After the first jaw and the second jaw move toward each other, an acting force is applied to both sides of the flowcell, enabling the flowcell to be gripped. When the first jaw and the second jaw move away from each other, the acting force on both sides of the flowcell is removed, thereby allowing the flowcell to be placed. The flowcell gripping mechanism can reliably grip or place the flowcell, and no additional design is required for the flowcell. The structure is simple, and the cost is low.

A station layout device according to the embodiments of the present disclosure cooperates with the flowcell transfer device according to the above embodiments. The station layout device includes at least one first station platform, the first station platform being provided with at least one biochemical station, at least one imaging station, at least one loading station, and at least one cleaning station; the station layout device further includes at least one second station platform or a bin, the second station platform or the bin being provided with at least one recycling station.

A sequencing system according to the embodiments of the present disclosure includes the flowcell transfer device according to the above embodiments, a fluidic mechanism, and an optical mechanism.

The flowcell transfer device transfers a flowcell at a loading station to a biochemical station, and the fluidic mechanism introduces a biochemical reagent into the flowcell to enable the flowcell to complete a biochemical reaction; the flowcell transfer device then transfers the flowcell at the biochemical station to an imaging station, the optical mechanism performs sequencing imaging on the flowcell and transfers a cleaning flowcell at the cleaning station to the biochemical station, and the fluidic mechanism introduces a cleaning reagent into the cleaning flowcell; after the sequencing imaging on the flowcell is completed, the flowcell transfer device transfers the flowcell at the imaging station to the recycling station, and after the cleaning flowcell completes station cleaning, the flowcell transfer device transfers the cleaning flowcell at the biochemical station to the cleaning station.

Additional aspects and advantages of the embodiments of the present disclosure will be partially set forth in the following description, and will partially become apparent from the following description or be appreciated by practice of the embodiments of the present disclosure.

### BRIEF DESCRIPTION OF THE DRAWINGS

The above and/or additional aspects and advantages of the embodiments of the present disclosure will become apparent and easily understood from the description of the embodiments with reference to the following drawings, among which:

FIG. 1 is a schematic structural diagram of a flowcell transfer device and a station layout device according to the embodiments of the present disclosure;

FIG. 2 is a partially enlarged view of portion A based on FIG. 1 according to the embodiments of the present disclosure;

FIG. 3 is a schematic structural diagram from another perspective of the flowcell transfer device and the station layout device according to the embodiments of the present disclosure;

FIG. 4 is a partially enlarged view of portion B based on FIG. 3 according to the embodiments of the present disclosure;

FIG. 5 is a schematic structural diagram of a first direction motion mechanism and a second direction motion mechanism according to the embodiments of the present disclosure;

FIG. 6 is a schematic structural diagram of a third direction motion mechanism, a rotation mechanism, and a flowcell gripping mechanism according to the embodiments of the present disclosure;

FIG. 7 is a schematic structural diagram of a rotation mechanism and a flowcell gripping mechanism according to the embodiments of the present disclosure;

FIG. 8 is a schematic structural diagram of a first gripper according to the embodiments of the present disclosure;

FIG. 9 is a schematic structural diagram from another perspective of the first gripper according to the embodiments of the present disclosure;

FIG. 10 is a schematic structural diagram of a flowcell according to the embodiments of the present disclosure;

FIG. 11 is a schematic structural diagram of a first station platform according to the embodiments of the present disclosure;

FIG. 12 is a schematic diagram of a station layout according to the embodiments of the present disclosure;

FIG. 13 is a schematic structural diagram of another flowcell transfer device and another station layout device according to the embodiments of the present disclosure;

FIG. 14 is a schematic structural diagram of a multi-axis mechanical arm according to the embodiments of the present disclosure;

FIG. 15 is a schematic structural diagram of another flowcell gripping mechanism according to the embodiments of the present disclosure;

FIG. 16 is a schematic structural diagram from another perspective of another flowcell gripping mechanism according to the embodiments of the present disclosure;

FIG. 17 is a schematic structural diagram of another first gripper according to the embodiments of the present disclosure;

FIG. 18 is a schematic structural diagram from another perspective of another first gripper according to the embodiments of the present disclosure;

FIG. 19 is a schematic structural diagram of another first station platform according to the embodiments of the present disclosure;

FIG. 20 is a schematic diagram of another station layout according to the embodiments of the present disclosure; and

FIG. 21 is a schematic flowchart of a flowcell transfer method according to the embodiments of the present disclosure.

### DETAILED DESCRIPTION OF THE INVENTION

The embodiments of the present disclosure are described in detail below, and the examples of the embodiments are shown in the drawings, throughout which identical or similar reference numerals represent identical or similar elements or elements having identical or similar functionality. The embodiments described below with reference to the drawings are exemplary and are merely intended to illustrate the present disclosure, and should not be construed as limiting the present disclosure.

In the description of the present disclosure, it should be understood that orientational or positional relationships indicated by terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, or “counterclockwise”, are those shown on the basis of the drawings, and are merely intended to facilitate and simplify the description rather than indicate or imply that the indicated apparatus or element must have a specific orientation and be configured and operated according to the specific orientation. Such relationships should not be construed as limiting the present disclosure. In addition, the terms “first” and “second” are used herein for descriptive purposes only and should not be construed as indicating or implying relative importance or implicitly indicating the number of technical features described. Therefore, features defined with “first” and “second” may explicitly or implicitly include one or more of the features. In the description of the present disclosure, unless otherwise clearly and specifically defined, the term “plurality” means two or more.

In the description of the present disclosure, it should be noted that unless otherwise clearly specified and defined, the terms “mount”, “link”, and “connect” should be interpreted in their broad sense. For example, the connection may be a fixed connection, detachable connection, or integral connection; a mechanical connection, electric connection, or communicative connection; or a direct connection, indirect connection through an intermediate, internal communication of two elements, or interaction between two elements. For those of ordinary skill in the art, the specific meanings of the aforementioned terms in the present disclosure can be interpreted according to specific conditions.

In the present disclosure, unless otherwise clearly specified and defined, a first feature being “above” or “below” a second feature may include that the first and second features are in direct contact and that the first and second features are not in direct contact but are in contact via an additional feature therebetween. Moreover, a first feature being “on”, “over” and “above” a second feature includes that the first feature is right above or obliquely above the second feature, or simply means that the first feature is at a vertically higher position than the second feature. A first feature being “under”, “beneath”, and “below” a second feature includes that the first feature is right below or obliquely below the second feature, or simply means that the first feature is at a vertically lower position than the second feature.

The following disclosure provides many different embodiments or examples for implementing different structures of the present disclosure. To simplify the disclosure of the present application, the components and settings of specific examples are described below. Certainly, the examples are merely exemplary and are not intended to limit the present disclosure. In addition, reference numerals and/or characters may be repeatedly used in different examples in the present disclosure for simplicity and clarity rather than to indicate the relationship between various embodiments and/or settings discussed. In addition, the present disclosure provides examples of various specific processes and materials, but those of ordinary skill in the art will recognize the application of other processes and/or the use of other materials.

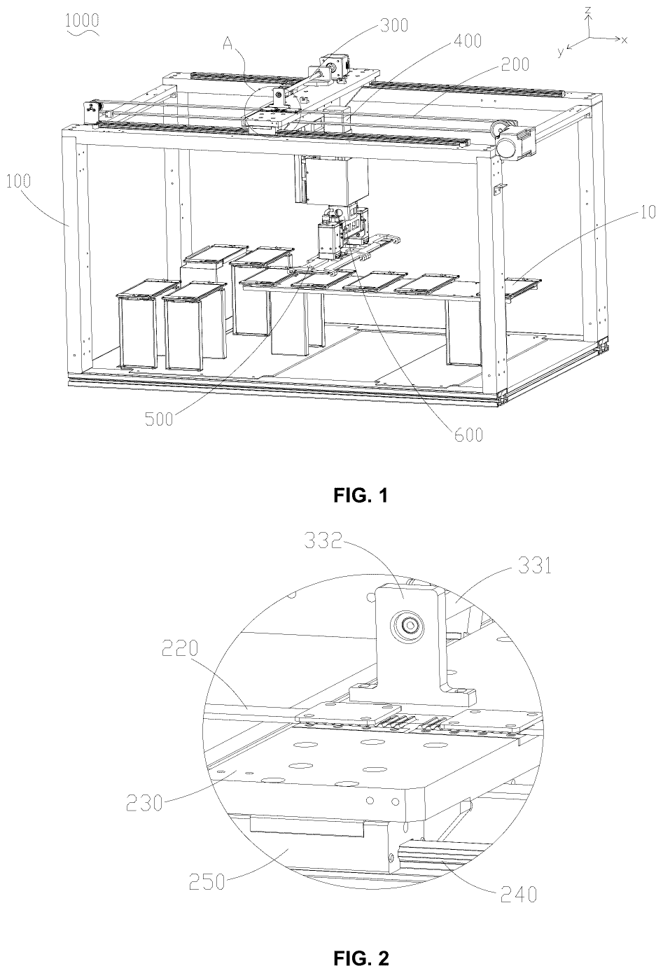

Referring to FIG. 1, a flowcell transfer device 1000 provided according to the embodiments of the present disclosure is used in a sequencing system. The flowcell transfer device 1000 includes a frame 100, a multi-dimensional motion mechanism, and a flowcell gripping mechanism 500. The multi-dimensional motion mechanism includes a first direction motion mechanism 200, a second direction motion mechanism 300, and a third direction motion mechanism 400. The first direction motion mechanism 200 is arranged on the frame 100, the second direction motion mechanism 300 is connected to the first direction motion mechanism 200, and the third direction motion mechanism 400 is connected to the second direction motion mechanism 300. The flowcell gripping mechanism 500 is arranged on the third direction motion mechanism 400.

The first direction motion mechanism 200, the second direction motion mechanism 300, and the third direction motion mechanism 400 drive the flowcell gripping mechanism 500 to move so as to achieve multi-dimensional motion, such that the flowcell gripping mechanism 500 is capable of gripping a flowcell 2000 at any station 10 and placing the flowcell 2000 at any other station 10.

The sequencing system may be a sequencer. The sequencer includes a control device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. Alternatively, the sequencing system may be an integrated system combining a sequencer and a server. The sequencer includes a control device, a communication device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. The control device then controls the communication device to send the sequencing data to the server, and the server stores and/or processes the sequencing data.

The first direction, the second direction, and the third direction may be mutually perpendicular to each other in pairs. For example, the first direction may be the positive or negative direction of the x-axis as shown in FIG. 1, the second direction may be the positive or negative direction of the y-axis as shown in FIG. 1, and the third direction may be the positive or negative direction of the z-axis as shown in FIG. 1. The first direction, the second direction, and the third direction may also refer to other directions, provided that the first direction, the second direction, and the third direction are different directions.

The frame 100 provides support for the first direction motion mechanism 200. The first direction motion mechanism 200 provides support for the second direction motion mechanism 300. The second direction motion mechanism 300 provides support for the third direction motion mechanism 400. The third direction motion mechanism 400 provides support for the flowcell gripping mechanism 500.

Since the second direction motion mechanism 300 is connected to the first direction motion mechanism 200, the first direction motion mechanism 200 drives the second direction motion mechanism 300 to move in the first direction. Since the third direction motion mechanism 400 is connected to the second direction motion mechanism 300, the second direction motion mechanism 300 drives the third direction motion mechanism 400 to move in the first direction. Since the flowcell gripping mechanism 500 is arranged on the third direction motion mechanism 400, the third direction motion mechanism 400 drives the flowcell gripping mechanism 500 to move in the first direction. Since the third direction motion mechanism 400 is connected to the second direction motion mechanism 300, the second direction motion mechanism 300 drives the third direction motion mechanism 400 to move in the second direction. Since the flowcell gripping mechanism 500 is arranged on the third direction motion mechanism 400, the third direction motion mechanism 400 drives the flowcell gripping mechanism 500 to move in the second direction. Since the flowcell gripping mechanism 500 is arranged on the third direction motion mechanism 400, the third direction motion mechanism 400 drives the flowcell gripping mechanism 500 to move in the third direction.

Under the motion of the first direction motion mechanism 200, the second direction motion mechanism 300, and the third direction motion mechanism 400, the flowcell gripping mechanism 500 can be driven to move in the first direction, the second direction, and the third direction, achieving multi-dimensional motion of the flowcell gripping mechanism 500. Thus, the flowcell gripping mechanism 500 can grip a flowcell 2000 at any station 10 and place the flowcell 2000 at any other station 10. For example, the station 10 includes a loading station 13, a biochemical station 12, an imaging station 11, a cleaning station 15, and a recycling station 14. A plurality of flowcells 2000 may be placed at the loading station 13, for example, three flowcells 2000 are placed at the loading station 13, and a cleaning flowcell 2000 may be placed at the cleaning station 15. The cleaning flowcell 2000 may be identical to the flowcell 2000, but since the cleaning flowcell 2000 only serves a cleaning function without biochemical reaction or sequencing imaging, it is referred to as the cleaning flowcell 2000. The flowcell gripping mechanism 500 grips a first flowcell 2000 at the loading station 13 and places the first flowcell at the biochemical station 12, where the first flowcell 2000 undergoes a biochemical reaction at the biochemical station 12. After the biochemical reaction is completed, the flowcell gripping mechanism 500 then grips the first flowcell 2000 at the biochemical station 12 and places the first flowcell at the imaging station 11, where the first flowcell 2000 undergoes sequencing imaging at the imaging station 11. The flowcell gripping mechanism 500 then grips a cleaning flowcell 2000 at the cleaning station 15 and places the cleaning flowcell at the biochemical station 12 to clean the components of the biochemical station 12, such as a liquid inlet/outlet. After cleaning is completed, the flowcell gripping mechanism 500 then grips the cleaning flowcell 2000 at the biochemical station 12 and places the cleaning flowcell at the cleaning station 15. The flowcell gripping mechanism 500 then grips a second flowcell 2000 at the loading station 13 and places the second flowcell at the biochemical station 12, where the second flowcell 2000 undergoes a biochemical reaction at the biochemical station 12. Alternatively, without cleaning the biochemical station 12, the flowcell gripping mechanism 500 grips the second flowcell 2000 at the loading station 13 and places the second flowcell at the biochemical station 12, where the second flowcell 2000 undergoes a biochemical reaction at the biochemical station 12. When the sequencing imaging on the first flowcell 2000 at the imaging station 11 is completed, the flowcell gripping mechanism 500 then grips the first flowcell 2000 at the imaging station 11 and places the first flowcell at the recycling station 14. When the second flowcell 2000 at the biochemical station 12 completes the biochemical reaction, the flowcell gripping mechanism 500 then grips the second flowcell 2000 at the biochemical station 12 and places the second flowcell at the imaging station 11, where the second flowcell 2000 undergoes sequencing imaging at the imaging station 11. The flowcell gripping mechanism 500 then grips the cleaning flowcell 2000 at the cleaning station 15 and places the cleaning flowcell at the biochemical station 12. After cleaning is completed, the flowcell gripping mechanism 500 then grips the cleaning flowcell 2000 at the biochemical station 12 and places the cleaning flowcell at the cleaning station 15. The flowcell gripping mechanism 500 then grips a third flowcell 2000 at the loading station 13 and places the third flowcell at the biochemical station 12, where the third flowcell 2000 undergoes a biochemical reaction at the biochemical station 12. Alternatively, without cleaning the biochemical station 12, the flowcell gripping mechanism 500 grips the third flowcell 2000 at the loading station 13 and places the third flowcell at the biochemical station 12, where the third flowcell 2000 undergoes a biochemical reaction at the biochemical station 12. When the sequencing imaging on the second flowcell 2000 at the imaging station 11 is completed, the flowcell gripping mechanism 500 then grips the second flowcell 2000 at the imaging station 11 and places the second flowcell at the recycling station 14. When the third flowcell 2000 at the biochemical station 12 completes the biochemical reaction, the flowcell gripping mechanism 500 then grips the third flowcell 2000 at the biochemical station 12 and places the third flowcell at the imaging station 11. When the sequencing imaging on the third flowcell 2000 at the imaging station 11 is completed, the flowcell gripping mechanism 500 then grips the third flowcell 2000 at the imaging station 11 and places the third flowcell at the recycling station 14. During the sequencing of the plurality of flowcells 2000, the flowcell gripping mechanism 500 transfers flowcells 2000 among different stations 10, enabling orderly transfer of each flowcell 2000. Due to the arrangement of multiple stations 10, the simultaneous operation of multiple flowcells 2000 at multiple stations 10 can be achieved, for example, one of the flowcells 2000 is undergoing a biochemical reaction while another flowcell 2000 is simultaneously undergoing sequencing imaging, thereby effectively improving sequencing efficiency.

After the flowcell 2000 completes one cycle—completing the biochemical reaction at the biochemical station 12 and then transferring to the imaging station 11 for sequencing imaging—there may be a situation where the entire sequencing is not yet finished, for example, only sequencing for cycles 1-10 has been performed, and sequencing for cycles 11-20 is still required. The flowcell gripping mechanism 500 needs to grip the cleaning flowcell 2000 from the cleaning station 15 and transfer the cleaning flowcell to the biochemical station 12 for cleaning. After that, the flowcell 2000 is transferred from the imaging station 11 to the biochemical station 12. Alternatively, without cleaning the biochemical station 12, the flowcell 2000 is transferred from the imaging station 11 to the biochemical station 12, followed by a biochemical reaction. After the biochemical reaction is completed, the flowcell is again transferred to the imaging station 11 for sequencing imaging. After the flowcell 2000 completes the entire sequencing, the flowcell gripping mechanism 500 then transfers the flowcell 2000 from the imaging station 11 to the recycling station 14. Further, after the flowcell 2000 is transferred from the biochemical station 12 to the imaging station 11 for the last time, the flowcell gripping mechanism 500 grips the cleaning flowcell 2000 from the cleaning station 15 and transfers the cleaning flowcell to the biochemical station 12 for cleaning, and grips the next flowcell 2000 from the loading station 13 and transfers the flowcell to the biochemical station.

Furthermore, a plurality of biochemical stations 12 may be arranged, allowing a plurality of flowcells 2000 to undergo biochemical reactions at their respective biochemical stations 12. As a specific implementation, for a flowcell 2000 that requires a biochemical reaction, when a biochemical station 12 is in an idle state (no flowcell 2000 is undergoing a biochemical reaction at the biochemical station 12), and if the biochemical station 12 has not previously performed a biochemical reaction, the flowcell gripping mechanism 500 transfers the flowcell 2000 that requires a biochemical reaction to the idle biochemical station 12 for the biochemical reaction. If the biochemical station 12 has previously performed a biochemical reaction, the flowcell gripping mechanism 500 transfers a cleaning flowcell 2000 from the cleaning station 15 to the biochemical station 12 for cleaning. After the cleaning is completed, the flowcell 2000 that requires a biochemical reaction is transferred to the biochemical station 12 for the biochemical reaction. Alternatively, without cleaning the biochemical station 12, the flowcell 2000 that requires a biochemical reaction is transferred to the biochemical station 12 to undergo the biochemical reaction. A plurality of imaging stations 11 may be arranged, allowing a plurality of flowcells 2000 to undergo sequencing imaging at their respective imaging stations 11. As a specific implementation, for a flowcell 2000 that requires sequencing imaging, when an imaging station 11 is in an idle state (no flowcell 2000 is undergoing sequencing imaging at the imaging station 11), the flowcell gripping mechanism 500 transfers the flowcell 2000 that requires sequencing imaging to the idle imaging station 11 for sequencing imaging. A plurality of cleaning flowcells 2000 may be placed on the cleaning station 15. Alternatively, a plurality of cleaning stations 15 may be arranged, and one cleaning flowcell 2000 is placed on each cleaning station 15, thereby facilitating the flowcell gripping mechanism 500 in transferring each cleaning flowcell 2000 to the biochemical station 12 that requires cleaning. As a specific implementation, for a biochemical station 12 that requires cleaning, when there is a cleaning flowcell 2000 at the cleaning station 15, the flowcell gripping mechanism 500 transfers the cleaning flowcell 2000 to the biochemical station 12 that requires cleaning, so as to clean the biochemical station 12. According to the above implementation, the arrangement of more biochemical stations 12, more imaging stations 11, and/or more cleaning flowcells 2000 can achieve more simultaneous sequencing processes, such as multiple biochemical reaction processes, multiple sequencing imaging processes, and/or multiple cleaning processes, thereby further improving sequencing efficiency.

In this embodiment, an initial position may be set, for example, by setting a position above the loading station 13 as the initial position. After the flowcell gripping mechanism 500 completes one operation of gripping and placing a flowcell 2000, the flowcell gripping mechanism 500 returns to the initial position and waits for the next operation of gripping and placing a flowcell 2000, with the flowcell gripping mechanism 500 starting from the initial position to perform the operation of gripping and placing the flowcell 2000. Alternatively, after each time the flowcell gripping mechanism 500 completes one operation of gripping and placing a flowcell 2000, the third direction motion mechanism 400 drives the flowcell gripping mechanism 500 to move in the third direction, such as moving upward. The flowcell gripping mechanism 500 stops at this position and waits for the next operation of gripping and placing a flowcell 2000, with the flowcell gripping mechanism 500 starting from this position to perform the operation of gripping and placing the flowcell 2000.

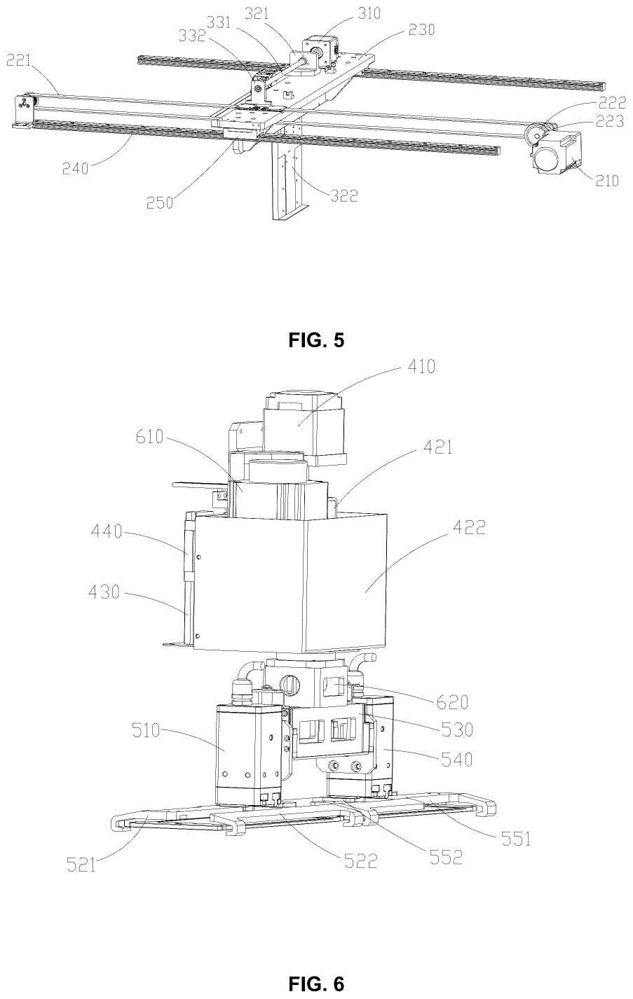

In some specific embodiments of the present disclosure, referring to FIGS. 1 to 5, the first direction motion mechanism 200 includes a first driving member 210, a synchronous belt assembly 220, and a moving plate 230. The first driving member 210 is arranged on the frame 100, the synchronous belt assembly 220 is connected to the first driving member 210, and the moving plate 230 moves under the drive of the synchronous belt assembly 220. The second direction motion mechanism 300 is arranged on the moving plate 230.

The synchronous belt assembly 220 is arranged on the frame 100, and the first driving member 210 can drive the synchronous belt assembly 220 to rotate. For example, if the first driving member 210 is a motor, the output shaft of the motor is connected to the synchronous belt assembly 220. When the motor operates, the synchronous belt assembly 220 is driven to rotate via the output shaft.

The moving plate 230 is arranged on the synchronous belt assembly 220. When the synchronous belt assembly 220 rotates, since the moving plate 230 is arranged on the synchronous belt assembly 220, the synchronous belt assembly 220 drives the moving plate 230 to move in the first direction. Since the second direction motion mechanism 300 is arranged on the moving plate 230, the moving plate 230 drives the second direction motion mechanism 300 to move in the first direction. Since the third direction motion mechanism 400 is connected to the second direction motion mechanism 300, the second direction motion mechanism 300 drives the third direction motion mechanism 400 to move in the first direction. Since the flowcell gripping mechanism 500 is arranged on the third direction motion mechanism 400, the third direction motion mechanism 400 drives the flowcell gripping mechanism 500 to move in the first direction.

In some specific embodiments of the present disclosure, referring to FIGS. 1 to 3 and 5, the synchronous belt assembly 220 includes a first synchronous pulley 224 arranged on the frame 100, a second synchronous pulley, and a synchronous belt 221 wound around the first synchronous pulley 224 and the second synchronous pulley. The moving plate 230 is arranged on the synchronous belt 221.

The synchronous belt assembly 220 further includes a first fixing seat and a second fixing seat. The first fixing seat and the second fixing seat are arranged on the frame 100 and are respectively located on both sides of the same side of the frame 100. The first synchronous pulley 224 is arranged on the first fixing seat, and the first fixing seat provides support for the first synchronous pulley 224. The second synchronous pulley is arranged on the second fixing seat, and the second fixing seat provides support for the second synchronous pulley.

The synchronous belt assembly 220 further includes a first reduction pulley, a second reduction pulley 222, and a reduction belt 223 wound around the first reduction pulley and the second reduction pulley 222. The first reduction pulley is connected to and coaxially arranged with the first driving member 210, and the second reduction pulley 222 is connected to and coaxially arranged with the second synchronous pulley. The first driving member 210 transmits power to the second synchronous pulley via the first reduction pulley and the second reduction pulley 222. The second synchronous pulley then cooperates with the first synchronous pulley 224 to drive the synchronous belt 221 to rotate. This can better control the motion accuracy and prevent the situation where excessive power causes the synchronous belt 221 to rotate too quickly and, as a result, the moving plate 230 is unable to move reliably.

The synchronous belt 221 is wound around the first synchronous pulley 224 and the second synchronous pulley, and the direction in which the synchronous belt 221 is arranged is the same as the first direction. Specifically, when the synchronous belt 221 rotates in the forward or reverse direction, the synchronous belt 221 drives the moving plate 230 to reciprocate in the first direction. When the synchronous belt 221 rotates, since the moving plate 230 is arranged on the synchronous belt 221, the synchronous belt 221 drives the moving plate 230 to move in the first direction. Since the second direction motion mechanism 300 is arranged on the moving plate 230, the moving plate 230 drives the second direction motion mechanism 300 to move in the first direction. Since the third direction motion mechanism 400 is connected to the second direction motion mechanism 300, the second direction motion mechanism 300 drives the third direction motion mechanism 400 to move in the first direction. Since the flowcell gripping mechanism 500 is arranged on the third direction motion mechanism 400, the third direction motion mechanism 400 drives the flowcell gripping mechanism 500 to move in the first direction. In this embodiment, the first direction motion mechanism 200 employs the movement mode of the synchronous belt 221, which can meet the requirements for long-stroke movement and, at the same time, occupies little space, has low cost, and offers high reliability in movement.

In some specific embodiments of the present disclosure, referring to FIG. 2, the moving plate 230 is provided with a first tooth part, and the synchronous belt 221 is provided with a second tooth part that is connected in a matching manner with the first tooth part.

From the perspective view in FIG. 2, it can be seen that the portion of the moving plate 230 in contact with the synchronous belt 221 is provided with the first tooth part. The inner circumference of the synchronous belt 221 is in contact with the moving plate 230; therefore, the inner circumference of the synchronous belt 221 is provided with the second tooth part, while the outer circumference of the synchronous belt 221, since it is not in contact with the moving plate 230, may not be provided with the second tooth part. Alternatively, it can also be implemented in such a way that the outer circumference of the synchronous belt 221 is in contact with the moving plate 230, hence the outer circumference of the synchronous belt 221 is provided with the second tooth part, and the inner circumference of the synchronous belt 221, since it is not in contact with the moving plate 230, may not be provided with the second tooth part. When the synchronous belt 221 rotates, by means of the cooperation between the first tooth part and the second tooth part, the synchronous belt 221 drives the moving plate 230 to move.

For example, the first tooth part is a triangular protrusion, and the second tooth part is a triangular protrusion. Alternatively, the first tooth part is an isosceles trapezoidal protrusion, and the second tooth part is an isosceles trapezoidal protrusion. Alternatively, the first tooth part is a protrusion that is narrow at the portion near the synchronous belt 221 and wide at the portion away from the synchronous belt 221, and the second tooth part is a protrusion that is narrow at the portion near the moving plate 230 and wide at the portion away from the moving plate 230.

In some specific embodiments of the present disclosure, referring to FIGS. 1 to 3 and 5, the first direction motion mechanism 200 further includes first guide rails 240 fixedly arranged on opposite sides of the frame 100, and first guide blocks 250 arranged on the first guide rails 240. One end of the moving plate 230 is connected to the first guide block 250 on one side of the frame, and the other end is connected to the first guide block 250 on the other side of the frame.

The direction in which the first guide rails 240 are arranged is the same as the first direction. During the movement of the moving plate 230, the moving plate 230 drives the first guide block 250 to move on the first guide rail 240. The first guide block 250 cooperates with the first guide rail 240 to provide a guiding effect for the moving plate 230, thereby ensuring the movement accuracy of the moving plate 230. In addition, the arrangement of the first guide block 250 and the first guide rail 240, as well as the arrangement of the moving plate 230 on the first guide block 250, can provide better support for the moving plate 230 and ensure that the moving plate 230 can move smoothly.

In some specific embodiments of the present disclosure, referring to FIGS. 1 and 3 to 5, the second direction motion mechanism 300 includes a second driving member 310 and a first connecting assembly. The second driving member 310 is connected to the first direction motion mechanism 200, the first connecting assembly is connected to the second driving member 310, and the third direction motion mechanism 400 is arranged on the first connecting assembly.

Specifically, the second driving member 310 is arranged on the moving plate 230 of the first direction motion mechanism 200.

The first connecting assembly is arranged on the moving plate 230, and the second driving member 310 can drive the first connecting assembly to move. For example, the second driving member 310 is a motor, and the output shaft of the motor is connected to the first connecting assembly. When the motor operates, the first connecting assembly is driven to move in the second direction via the output shaft.

When the first connecting assembly moves, since the third direction motion mechanism 400 is arranged on the first connecting assembly, the first connecting assembly drives the third direction motion mechanism 400 to move in the second direction. Since the flowcell gripping mechanism 500 is arranged on the third direction motion mechanism 400, the third direction motion mechanism 400 drives the flowcell gripping mechanism 500 to move in the second direction.

In some specific embodiments of the present disclosure, referring to FIGS. 1 and 3 to 5, the first connecting assembly includes a first connecting plate 321 and a fixing plate 322. The first connecting plate 321 is arranged on the first direction motion mechanism 200 and is connected to the second driving member 310. The fixing plate 322 is arranged on the first direction motion mechanism 200 and is fixedly connected to the first connecting plate 321. The third direction motion mechanism 400 is arranged on the fixing plate 322.

Specifically, the first connecting plate 321 is arranged on the moving plate 230 of the first direction motion mechanism 200, and the fixing plate 322 is arranged on the moving plate 230 of the first direction motion mechanism 200.

The second driving member 310 drives the first connecting plate 321 to move in the second direction. Since the fixing plate 322 is fixedly connected to the first connecting plate 321, the first connecting plate 321 drives the fixing plate 322 to move in the second direction. Since the third direction motion mechanism 400 is arranged on the fixing plate 322, the fixing plate 322 drives the third direction motion mechanism 400 to move in the second direction. Since the flowcell gripping mechanism 500 is arranged on the third direction motion mechanism 400, the third direction motion mechanism 400 drives the flowcell gripping mechanism 500 to move in the second direction. The third direction motion mechanism 400 is arranged on the fixing plate 322, rather than on the first connecting plate 321. When the second driving member 310 drives the first connecting plate 321 to move, the first connecting plate 321 does not directly drive the third direction motion mechanism 400 to move, but instead indirectly drives the third direction motion mechanism 400 via the fixing plate 322, resulting in more reliable power transmission and thereby achieving more precise movement accuracy.

In some specific embodiments of the present disclosure, referring to FIGS. 1 to 3 and 5, the second direction motion mechanism 300 further includes a first lead screw 331 connected to the output shaft of the second driving member 310. Threads are formed on the surface of the first lead screw 331. The first connecting plate 321 is provided with a threaded hole that matches the first lead screw 331, and the first lead screw 331 passes through the threaded hole and is in threaded connection with the threaded hole.

The direction in which the first lead screw 331 is arranged is the same as the second direction. The second driving member 310 drives the first lead screw 331 to rotate. By means of the engagement between the threads on the first lead screw 331 and the threaded hole on the first connecting plate 321, the first lead screw 331 drives the first connecting plate 321 to move in the second direction. Specifically, when the first lead screw 331 rotates in the positive or negative direction, the first lead screw 331 drives the first connecting plate 321 to reciprocate in the second direction. When the first lead screw 331 drives the first connecting plate 321 to move in the second direction, since the fixing plate 322 is fixedly connected to the first connecting plate 321, the first connecting plate 321 drives the fixing plate 322 to move in the second direction; since the third direction motion mechanism 400 is arranged on the fixing plate 322, the fixing plate 322 drives the third direction motion mechanism 400 to move in the second direction; since the flowcell gripping mechanism 500 is arranged on the third direction motion mechanism 400, the third direction motion mechanism 400 drives the flowcell gripping mechanism 500 to move in the second direction.

Furthermore, the second direction motion mechanism 300 further includes a third fixing seat 332. One end of the first lead screw 331 is connected to the output shaft of the second driving member 310, and the other end of the first lead screw 331 is connected to the third fixing seat 332. The third fixing seat 332 provides support for the first lead screw 331, such that both ends of the first lead screw 331 are supported. When the first lead screw 331 drives the first connecting plate 321 to move, even after long-term use, it is not likely to cause rotational deviation in the first lead screw 331, such that the first connecting plate 321 can maintain long-term and reliable movement.

In some specific embodiments of the present disclosure, referring to FIGS. 1 and 3 to 5, the second direction motion mechanism 300 further includes a second guide rail 340 arranged on the first direction motion mechanism 200 and a second guide block 350 arranged on the second guide rail 340. The fixing plate 322 is arranged on the second guide block 350.

Specifically, the second guide rail 340 is arranged on the moving plate 230 of the first direction motion mechanism 200.

The direction in which the second guide rail 340 is arranged is the same as the second direction. During the movement of the fixing plate 322, the fixing plate 322 drives the second guide block 350 to move on the second guide rail 340. The second guide block 350 cooperates with the second guide rail 340 to provide a guiding effect for the fixing plate 322, thereby ensuring the movement accuracy of the fixing plate 322. In addition, the arrangement of the second guide block 350 and the second guide rail 340, as well as the arrangement of the fixing plate 322 on the second guide block 350, can provide better support for the fixing plate 322 and ensure that the fixing plate 322 can move smoothly.

In some specific embodiments of the present disclosure, referring to FIGS. 1 and 6, the third direction motion mechanism 400 includes a third driving member 410 and a second connecting assembly. The third driving member 410 is connected to the second direction motion mechanism, the second connecting assembly is connected to the third driving member 410, and the flowcell gripping mechanism 500 is arranged on the second connecting assembly.

Specifically, the third driving member 410 is arranged on the first connecting assembly of the second direction motion mechanism 300.

The third driving member 410 is arranged on the first connecting assembly; specifically, the third driving member 410 is arranged on the fixing plate 322. The second driving member 310 drives the first connecting plate 321 to move in the second direction, the first connecting plate 321 drives the fixing plate 322 to move in the second direction, and the fixing plate 322 drives the third driving member 410 to move in the second direction.

The second connecting assembly is arranged on the first connecting assembly; specifically, the second connecting assembly is arranged on the fixing plate 322. The second driving member 310 drives the first connecting plate 321 to move in the second direction, the first connecting plate 321 drives the fixing plate 322 to move in the second direction, and the fixing plate 322 drives the second connecting assembly to move in the second direction.

The third driving member 410 can drive the second connecting assembly to move. For example, the third driving member 410 is a motor, and the output shaft of the motor is connected to the second connecting assembly. When the motor operates, the second connecting assembly is driven to move in the third direction via the output shaft.

When the second connecting assembly moves, since the flowcell gripping mechanism 500 is arranged on the second connecting assembly, the second connecting assembly drives the flowcell gripping mechanism 500 to move in the third direction.

In some specific embodiments of the present disclosure, referring to FIGS. 1 and 6, the second connecting assembly includes a second connecting plate 421 and a movable seat 422. The second connecting plate 421 is connected to the third driving member 410, the movable seat 422 is fixedly connected to the second connecting plate 421, and the flowcell gripping mechanism 500 is arranged on the movable seat 422.

The movable seat 422 is arranged on the first connecting assembly; specifically, the movable seat 422 is arranged on the fixing plate 322. The second driving member 310 drives the first connecting plate 321 to move in the second direction, the first connecting plate 321 drives the fixing plate 322 to move in the second direction, the fixing plate 322 drives the movable seat 422 to move in the second direction, and the movable seat 422 drives the second connecting plate 421 to move in the second direction.

The third driving member 410 drives the second connecting plate 421 to move in the third direction. Since the movable seat 422 is fixedly connected to the second connecting plate 421, the second connecting plate 421 drives the movable seat 422 to move in the third direction. Since the flowcell gripping mechanism 500 is arranged on the movable seat 422, the movable seat 422 drives the flowcell gripping mechanism 500 to move in the third direction. The flowcell gripping mechanism 500 is arranged on the movable seat 422, rather than on the second connecting plate 421. When the third driving member 410 drives the second connecting plate 421 to move, the second connecting plate 421 does not directly drive the flowcell gripping mechanism 500 to move, but instead indirectly drives the flowcell gripping mechanism 500 via the movable seat 422, resulting in more reliable power transmission and thereby achieving more precise movement accuracy.

In some specific embodiments of the present disclosure, referring to FIGS. 1 and 6, the second connecting assembly further includes a second lead screw connected to the output shaft of the third driving member 410. Threads are formed on the surface of the second lead screw. The second connecting plate 421 is provided with a threaded hole that matches the second lead screw, and the second lead screw passes through the threaded hole and is in threaded connection with the threaded hole.

The direction in which the second lead screw is arranged is the same as the third direction. The third driving member 410 drives the second lead screw to rotate. By means of the engagement between the threads on the second lead screw and the threaded hole on the second connecting plate 421, the second lead screw drives the second connecting plate 421 to move in the third direction. Specifically, when the second lead screw rotates in the positive or negative direction, the second lead screw drives the second connecting plate 421 to reciprocate in the third direction. When the second lead screw drives the second connecting plate 421 to move in the third direction, since the movable seat 422 is fixedly connected to the second connecting plate 421, the second connecting plate 421 drives the movable seat 422 to move in the third direction; since the flowcell gripping mechanism 500 is arranged on the movable seat 422, the movable scat 422 drives the flowcell gripping mechanism 500 to move in the third direction.

In some specific embodiments of the present disclosure, referring to FIGS. 1 and 6, the third direction motion mechanism 400 further includes a third guide rail 430 arranged on the second direction motion mechanism and a third guide block 440 arranged on the third guide rail 430. The movable seat 422 is arranged on the third guide block 440.

Specifically, the third guide rail 430 is arranged on the first connecting assembly of the second direction motion mechanism 300.

The third guide rail 430 is arranged on the first connecting assembly; specifically, the third guide rail 430 is arranged on the fixing plate 322. The second driving member 310 drives the first connecting plate 321 to move in the second direction, the first connecting plate 321 drives the fixing plate 322 to move in the second direction, and the fixing plate 322 drives the third guide rail 430 to move in the second direction. Since the movable seat 422 is arranged on the third guide block 440 located on the third guide rail 430, the movable seat 422 moves in the second direction, and the movable seat 422 drives the second connecting plate 421 to move in the second direction.

The direction in which the third guide rail 430 is arranged is the same as the third direction. During the movement of the movable seat 422 in the third direction, the movable seat 422 drives the third guide block 440 to move on the third guide rail 430. The third guide block 440 cooperates with the third guide rail 430 to provide a guiding effect for the movable seat 422, thereby ensuring the movement accuracy of the movable seat 422. In addition, the arrangement of the third guide block 440 and the third guide rail 430, as well as the arrangement of the movable seat 422 on the third guide block 440, can provide better support for the movable seat 422 and ensure that the movable seat 422 can move smoothly.

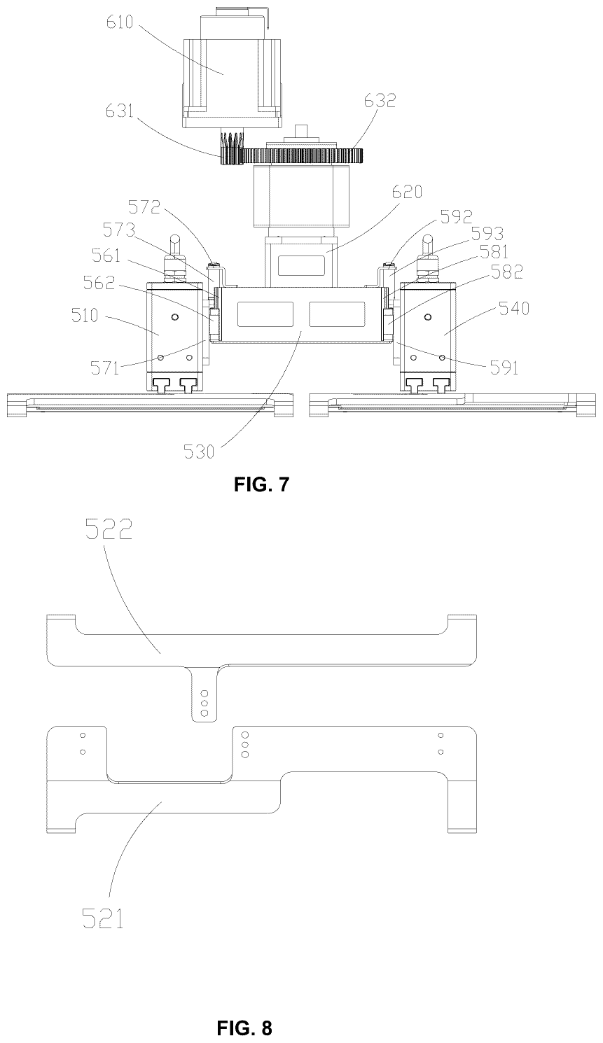

In some specific embodiments of the present disclosure, referring to FIGS. 1, 6, and 7, the flowcell gripping mechanism 500 includes a first gripper driving member 510 and a first gripper. The first gripper driving member 510 is connected to the third direction motion mechanism, and the first gripper is connected to the first gripper driving member 510. The first gripper includes oppositely arranged first jaw 521 and second jaw 522. Driven by the first gripper driving member 510, the first jaw 521 and the second jaw 522 move toward or away from each other to grip or place the flowcell 2000.

Specifically, the first gripper driving member 510 is arranged on the second connecting assembly of the third direction motion mechanism.

The first gripper driving member 510 is arranged on the second connecting assembly; specifically, the first gripper driving member 510 is arranged on the movable seat 422. The third driving member 410 drives the second connecting plate 421 to move in the third direction, the second connecting plate 421 drives the movable seat 422 to move in the third direction, and the movable seat 422 drives the first gripper driving member 510 to move in the third direction.

The first jaw 521 is provided with a first claw tip 5211 that curves inward, and the second jaw 522 is provided with a second claw tip 5221 that curves inward. Driven by the first gripper driving member 510, the first jaw 521 and the second jaw 522 move toward each other, such that the flowcell 2000 can be gripped by the first claw tip 5211 and the second claw tip 5221.

Driven by the first direction motion mechanism 200 and the second direction motion mechanism 300, the flowcell gripping mechanism 500 moves to a position above the flowcell 2000 to be gripped. The first gripper driving member 510 drives the first jaw 521 and the second jaw 522 to move away from each other. Next, the third direction motion mechanism 400 drives the flowcell gripping mechanism 500 to move in the third direction, such as moving downward, and the first gripper driving member 510 drives the first jaw 521 and the second jaw 522 to move toward each other, such that the flowcell 2000 is gripped by the first claw tip 5211 and the second claw tip 5221. Then, the third direction motion mechanism 400 drives the flowcell gripping mechanism 500 to move in the third direction, such as moving upward. Driven by the first direction motion mechanism 200 and the second direction motion mechanism 300, the flowcell gripping mechanism 500 moves to a position above where the flowcell 2000 is to be placed. Subsequently, the third direction motion mechanism 400 drives the flowcell gripping mechanism 500 to move in the third direction, such as moving downward, and the first gripper driving member 510 drives the first jaw 521 and the second jaw 522 to move away from each other to place the flowcell 2000.

The workflow of the flowcell gripping mechanism 500 is described in conjunction with the station 10.

For example, when the flowcell 2000 at the loading station 13 needs to be transferred to the biochemical station 12, the flowcell gripping mechanism 500, driven by the first direction motion mechanism 200 and the second direction motion mechanism 300, moves to a position above the loading station 13. The first gripper driving member 510 drives the first jaw 521 and the second jaw 522 to move away from each other. Next, the third direction motion mechanism 400 drives the flowcell gripping mechanism 500 to move in the third direction, such as moving downward, and the first gripper driving member 510 drives the first jaw 521 and the second jaw 522 to move toward each other, such that the flowcell 2000 is gripped by the first claw tip 5211 and the second claw tip 5221. Then, the third direction motion mechanism 400 drives the flowcell gripping mechanism 500 to move in the third direction, such as moving upward. Driven by the first direction motion mechanism 200 and the second direction motion mechanism 300, the flowcell gripping mechanism 500 moves to a position above the biochemical station 12. Subsequently, the third direction motion mechanism 400 drives the flowcell gripping mechanism 500 to move in the third direction, such as moving downward, and the first gripper driving member 510 drives the first jaw 521 and the second jaw 522 to move away from each other, so as to place the flowcell 2000 on the biochemical station 12.

For example, when the flowcell 2000 at the biochemical station 12 needs to be transferred to the imaging station 11, the flowcell gripping mechanism 500, driven by the first direction motion mechanism 200 and the second direction motion mechanism 300, moves to a position above the biochemical station 12. The first gripper driving member 510 drives the first jaw 521 and the second jaw 522 to move away from each other. Next, the third direction motion mechanism 400 drives the flowcell gripping mechanism 500 to move in the third direction, such as moving downward, and the first gripper driving member 510 drives the first jaw 521 and the second jaw 522 to move toward each other, such that the flowcell 2000 is gripped by the first claw tip 5211 and the second claw tip 5221. Then, the third direction motion mechanism 400 drives the flowcell gripping mechanism 500 to move in the third direction, such as moving upward. Driven by the first direction motion mechanism 200 and the second direction motion mechanism 300, the flowcell gripping mechanism 500 moves to a position above the imaging station 11. Subsequently, the third direction motion mechanism 400 drives the flowcell gripping mechanism 500 to move in the third direction, such as moving downward, and the first gripper driving member 510 drives the first jaw 521 and the second jaw 522 to move away from each other, so as to place the flowcell 2000 on the imaging station 11.

For example, when the flowcell 2000 at the imaging station 11 needs to be transferred to the recycling station 14, the flowcell gripping mechanism 500, driven by the first direction motion mechanism 200 and the second direction motion mechanism 300, moves to a position above the imaging station 11. The first gripper driving member 510 drives the first jaw 521 and the second jaw 522 to move away from each other. Next, the third direction motion mechanism 400 drives the flowcell gripping mechanism 500 to move in the third direction, such as moving downward, and the first gripper driving member 510 drives the first jaw 521 and the second jaw 522 to move toward each other, such that the flowcell 2000 is gripped by the first claw tip 5211 and the second claw tip 5221. Then, the third direction motion mechanism 400 drives the flowcell gripping mechanism 500 to move in the third direction, such as moving upward. Driven by the first direction motion mechanism 200 and the second direction motion mechanism 300, the flowcell gripping mechanism 500 moves to a position above the recycling station 14. Subsequently, the third direction motion mechanism 400 drives the flowcell gripping mechanism 500 to move in the third direction, such as moving downward, and the first gripper driving member 510 drives the first jaw 521 and the second jaw 522 to move away from each other, so as to place the flowcell 2000 on the recycling station 14.

For example, when the cleaning flowcell 2000 at the cleaning station 15 needs to be transferred to the biochemical station 12, the flowcell gripping mechanism 500, driven by the first direction motion mechanism 200 and the second direction motion mechanism 300, moves to a position above the cleaning station 15. The first gripper driving member 510 drives the first jaw 521 and the second jaw 522 to move away from each other. Next, the third direction motion mechanism 400 drives the flowcell gripping mechanism 500 to move in the third direction, such as moving downward, and the first gripper driving member 510 drives the first jaw 521 and the second jaw 522 to move toward each other, such that the cleaning flowcell 2000 is gripped by the first claw tip 5211 and the second claw tip 5221. Then, the third direction motion mechanism 400 drives the flowcell gripping mechanism 500 to move in the third direction, such as moving upward. Driven by the first direction motion mechanism 200 and the second direction motion mechanism 300, the flowcell gripping mechanism 500 moves to a position above the biochemical station 12. Subsequently, the third direction motion mechanism 400 drives the flowcell gripping mechanism 500 to move in the third direction, such as moving downward, and the first gripper driving member 510 drives the first jaw 521 and the second jaw 522 to move away from each other, so as to place the cleaning flowcell 2000 on the biochemical station 12.

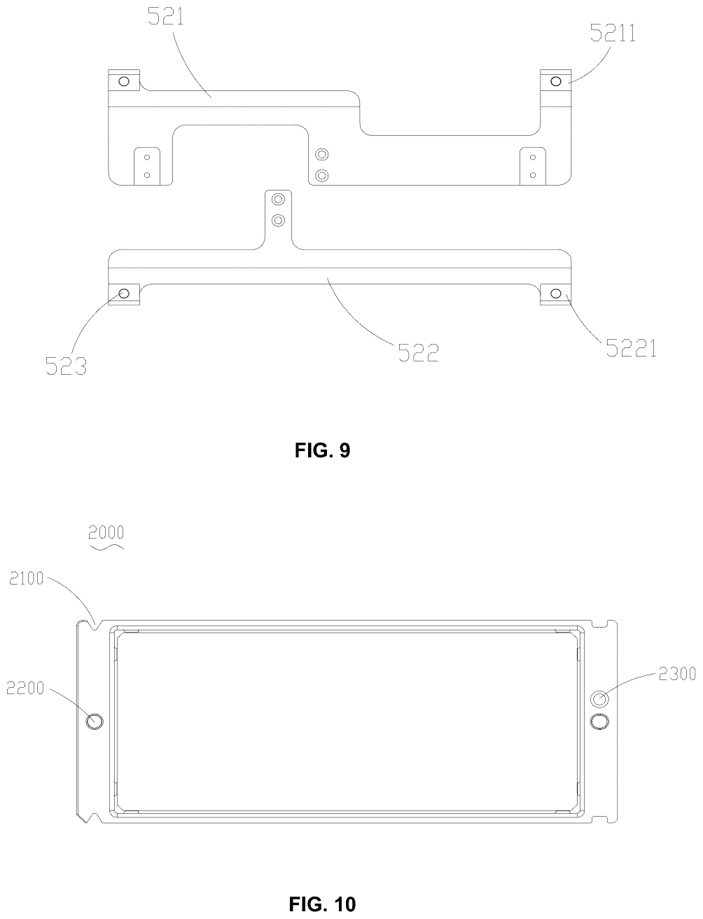

In some specific embodiments of the present disclosure, referring to FIGS. 8 and 9, both the first jaw 521 and the second jaw 522 are provided with a first positioning pin 523. When the first jaw 521 and the second jaw 522 move toward or away from each other, the first positioning pin 523 contacts or moves away from the positioning groove 2100 of the flowcell 2000.

In the first jaw 521, the first positioning pin 523 is arranged on the first claw tip 5211; in the second jaw 522, the first positioning pin 523 is arranged on the second claw tip 5221. When the first gripper driving member 510 drives the first jaw 521 and the second jaw 522 to move toward each other, the first positioning pin 523 contacts the positioning groove 2100 of the flowcell 2000, and the first claw tip 5211 and the second claw tip 5221 support the flowcell 2000 from below, thereby achieving gripping of the flowcell 2000. When the first gripper driving member 510 drives the first jaw 521 and the second jaw 522 to move away from each other, the first positioning pin 523 disengages from the positioning groove 2100 of the flowcell 2000, thereby achieving placement of the flowcell 2000. The arrangement of the first positioning pin 523 satisfies the accuracy requirements for gripping the flowcell 2000 and can prevent the flowcell 2000 from falling due to a power failure.

In some specific embodiments of the present disclosure, referring to FIG. 10, the flowcell 2000 is provided with a plurality of positioning grooves 2100, the plurality of positioning grooves 2100 each have either a first shape or a second shape, the first shape being different from the second shape. For example, the flowcell 2000 is provided with positioning grooves 2100 at the four ends thereof. The positioning grooves 2100 located at both ends of one long side of the flowcell 2000 are respectively a rectangular groove and a triangular groove. The positioning grooves 2100 located at both ends of the other long side of the flowcell 2000 are respectively a rectangular groove and a triangular groove. The two rectangular grooves are opposite to each other, and the two triangular grooves are opposite to each other. The arrangement of a plurality of positioning grooves 2100 with different shapes can further improve the gripping accuracy for the flowcell 2000.

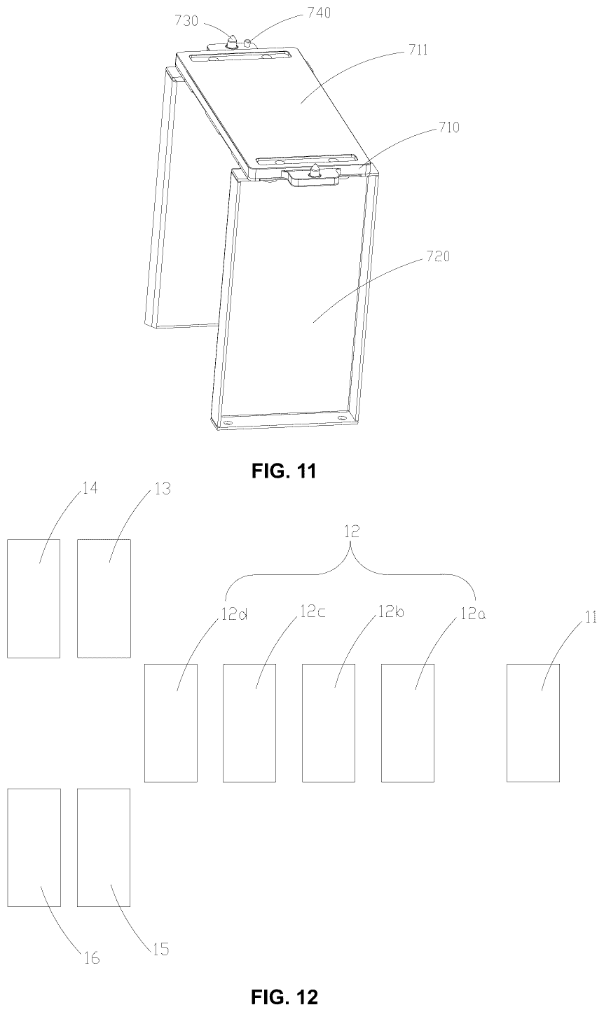

In some specific embodiments of the present disclosure, referring to FIG. 10, a positioning hole 2200 and a poka-yoke hole 2300 are provided at both ends of the flowcell 2000. Referring to FIG. 11, the station 10 is provided with the station platform, and the station platform is provided with a positioning shaft 730 that cooperates with the positioning hole 2200 and a poka-yokc shaft 740 that cooperates with the poka-yoke hole 2300. When the flowcell 2000 is placed on the station 10, the positioning shaft 730 is inserted into the positioning hole 2200 to achieve positioning of the flowcell 2000, and the poka-yoke shaft 740 is inserted into the poka-yokc hole 2300 to achieve poka-yoke of the flowcell 2000.

Alternatively, a positioning shaft and a poka-yoke shaft are provided at both ends of the flowcell 2000. The station 10 is provided with a station platform, and the station platform is provided with a positioning hole that cooperates with the positioning shaft and a poka-yoke hole that cooperates with the poka-yoke shaft. When the flowcell 2000 is placed on the station 10, the positioning shaft is inserted into the positioning hole to achieve positioning of the flowcell 2000, and the poka-yoke shaft is inserted into the poka-yoke hole to achieve poka-yoke of the flowcell 2000.

In some specific embodiments of the present disclosure, referring to FIGS. 1, 6, and 7, the flowcell gripping mechanism 500 further includes a mounting base 530, a second gripper driving member 540, and a second gripper. The mounting base 530 is connected to the third direction motion mechanism 400. The first gripper driving member 510 is arranged on the mounting base 530, the second gripper driving member 540 is arranged on the mounting base 530, and the second gripper is connected to the second gripper driving member 540. The second gripper includes oppositely arranged third jaw 551 and fourth jaw 552. Driven by the second gripper driving member 540, the third jaw 551 and the fourth jaw 552 move toward or away from each other to grip or place the flowcell 2000.

Specifically, the mounting base 530 is connected to the second connecting assembly of the third direction motion mechanism 400.

Specifically, the first gripper driving member 510 is arranged on one side of the mounting base 530, and the second gripper driving member 540 is arranged on the other side of the mounting base 530.

The mounting base 530 is connected to the second connecting assembly; specifically, the mounting base 530 is connected to the movable seat 422. The third driving member 410 drives the second connecting plate 421 to move in the third direction, the second connecting plate 421 drives the movable seat 422 to move in the third direction, the movable seat 422 drives the mounting base 530 to move in the third direction, and the mounting base 530 drives the first gripper driving member 510 and the second gripper driving member 540 to move in the third direction.

The third jaw 551 is provided with a third claw tip that curves inward, and the fourth jaw 552 is provided with a fourth claw tip that curves inward. Driven by the second gripper driving member 540, the third jaw 551 and the fourth jaw 552 move toward each other, such that the flowcell 2000 can be gripped by the third claw tip and the fourth claw tip.

Driven by the first direction motion mechanism 200 and the second direction motion mechanism 300, the second gripper driving member 540 moves to a position above the flowcell 2000 to be gripped. The second gripper driving member 540 drives the third jaw 551 and the fourth jaw 552 to move away from each other. Next, the third direction motion mechanism 400 drives the second gripper driving member 540 to move in the third direction, such as moving downward. The second gripper driving member 540 drives the third jaw 551 and the fourth jaw 552 to move toward each other, such that the flowcell 2000 is gripped by the third claw tip and the fourth claw tip. Then, the third direction motion mechanism 400 drives the second gripper driving member 540 to move in the third direction, such as moving upward. Driven by the first direction motion mechanism 200 and the second direction motion mechanism 300, the second gripper driving member 540 moves to a position above where the flowcell 2000 needs to be placed. Subsequently, the third direction motion mechanism 400 drives the second gripper driving member 540 to move in the third direction, such as moving downward. The second gripper driving member 540 drives the third jaw 551 and the fourth jaw 552 to move away from each other to place the flowcell 2000.

The workflow of the second gripper driving member 540 and the second gripper is described in conjunction with the station 10.

For example, when the flowcell 2000 at the loading station 13 needs to be transferred to the biochemical station 12, the second gripper driving member 540, driven by the first direction motion mechanism 200 and the second direction motion mechanism 300, moves to a position above the loading station 13. The second gripper driving member 540 drives the third jaw 551 and the fourth jaw 552 to move away from each other. Next, the third direction motion mechanism 400 drives the second gripper driving member 540 to move in the third direction, such as moving downward, and the second gripper driving member 540 drives the third jaw 551 and the fourth jaw 552 to move toward each other, such that the flowcell 2000 is gripped by the third claw tip and the fourth claw tip. Then, the third direction motion mechanism 400 drives the second gripper driving member 540 to move in the third direction, such as moving upward. Driven by the first direction motion mechanism 200 and the second direction motion mechanism 300, the second gripper driving member 540 moves to a position above the biochemical station 12. Subsequently, the third direction motion mechanism 400 drives the second gripper driving member 540 to move in the third direction, such as moving downward, and the second gripper driving member 540 drives the third jaw 551 and the fourth jaw 552 to move away from each other, so as to place the flowcell 2000 on the biochemical station 12.

For example, when the flowcell 2000 at the biochemical station 12 needs to be transferred to the imaging station 11, the second gripper driving member 540, driven by the first direction motion mechanism 200 and the second direction motion mechanism 300, moves to a position above the biochemical station 12. The second gripper driving member 540 drives the third jaw 551 and the fourth jaw 552 to move away from each other. Next, the third direction motion mechanism 400 drives the second gripper driving member 540 to move in the third direction, such as moving downward, and the second gripper driving member 540 drives the third jaw 551 and the fourth jaw 552 to move toward each other, such that the flowcell 2000 is gripped by the third claw tip and the fourth claw tip. Then, the third direction motion mechanism 400 drives the second gripper driving member 540 to move in the third direction, such as moving upward. Driven by the first direction motion mechanism 200 and the second direction motion mechanism 300, the second gripper driving member 540 moves to a position above the imaging station 11. Subsequently, the third direction motion mechanism 400 drives the second gripper driving member 540 to move in the third direction, such as moving downward, and the second gripper driving member 540 drives the third jaw 551 and the fourth jaw 552 to move away from each other, so as to place the flowcell 2000 on the imaging station 11.

For example, when the flowcell 2000 at the imaging station 11 needs to be transferred to the recycling station 14, the second gripper driving member 540, driven by the first direction motion mechanism 200 and the second direction motion mechanism 300, moves to a position above the imaging station 11. The second gripper driving member 540 drives the third jaw 551 and the fourth jaw 552 to move away from each other. Next, the third direction motion mechanism 400 drives the second gripper driving member 540 to move in the third direction, such as moving downward, and the second gripper driving member 540 drives the third jaw 551 and the fourth jaw 552 to move toward each other, such that the flowcell 2000 is gripped by the third claw tip and the fourth claw tip. Then, the third direction motion mechanism 400 drives the second gripper driving member 540 to move in the third direction, such as moving upward. Driven by the first direction motion mechanism 200 and the second direction motion mechanism 300, the second gripper driving member 540 moves to a position above the recycling station 14. Subsequently, the third direction motion mechanism 400 drives the second gripper driving member 540 to move in the third direction, such as moving downward, and the second gripper driving member 540 drives the third jaw 551 and the fourth jaw 552 to move away from each other, so as to place the flowcell 2000 on the recycling station 14.

For example, when the cleaning flowcell 2000 at the cleaning station 15 needs to be transferred to the biochemical station 12, the second gripper driving member 540, driven by the first direction motion mechanism 200 and the second direction motion mechanism 300, moves to a position above the cleaning station 15. The second gripper driving member 540 drives the third jaw 551 and the fourth jaw 552 to move away from each other. Next, the third direction motion mechanism 400 drives the second gripper driving member 540 to move in the third direction, such as moving downward, and the second gripper driving member 540 drives the third jaw 551 and the fourth jaw 552 to move toward each other, such that the cleaning flowcell 2000 is gripped by the third claw tip and the fourth claw tip. Then, the third direction motion mechanism 400 drives the second gripper driving member 540 to move in the third direction, such as moving upward. Driven by the first direction motion mechanism 200 and the second direction motion mechanism 300, the second gripper driving member 540 moves to a position above the biochemical station 12. Subsequently, the third direction motion mechanism 400 drives the second gripper driving member 540 to move in the third direction, such as moving downward, and the second gripper driving member 540 drives the third jaw 551 and the fourth jaw 552 to move away from each other, so as to place the cleaning flowcell 2000 on the biochemical station 12.

In this embodiment, two sets of gripper mechanisms are provided in the flowcell gripping mechanism 500, which expands the application scenarios. For example, one set of gripper mechanism can grip the flowcell 2000, while the other set of gripper mechanism can place the flowcell 2000. Alternatively, the two sets of gripper mechanisms can first grip flowcells 2000 and then sequentially place the flowcells 2000, and so on. This can shorten the movement path of the flowcell gripping mechanism 500, reduce the time for gripping and placing flowcells 2000, and greatly improve efficiency.

In some specific embodiments of the present disclosure, both the third jaw 551 and the fourth jaw 552 are provided with a second positioning pin. When the third jaw 551 and the fourth jaw 552 move toward or away from each other, the second positioning pin contacts or disengages from the positioning groove 2100 of the flowcell 2000.

In the third jaw 551, the second positioning pin is arranged on the third claw tip; in the fourth jaw 552, the second positioning pin is arranged on the fourth claw tip. When the second gripper driving member 540 drives the third jaw 551 and the fourth jaw 552 to move toward each other, the second positioning pin contacts the positioning groove 2100 of the flowcell 2000, and the third claw tip and the fourth claw tip support the flowcell 2000 from below, thereby achieving gripping of the flowcell 2000. When the second gripper driving member 540 drives the third jaw 551 and the fourth jaw 552 to move away from each other, the second positioning pin disengages from the positioning groove 2100 of the flowcell 2000, thereby achieving placement of the flowcell 2000. The arrangement of the second positioning pin satisfies the accuracy requirements for gripping the flowcell 2000 and can prevent the flowcell 2000 from falling due to a power failure.

In some specific embodiments of the present disclosure, referring to FIGS. 1, 6, and 7, the flowcell gripping mechanism 500 further includes a first connecting block 571, a first pressing plate 572, and a first clastic member 573. The first connecting block 571 is arranged on the first gripper driving member 510, the first pressing plate 572 is arranged on the mounting base 530, and the first clastic member 573 is arranged between the first connecting block 571 and the first pressing plate 572.

The first elastic member 573 may include, but is not limited to, a spring, a resilient sheet, a rubber ring, or a rubber sheet.

The third direction motion mechanism 400 drives the mounting base 530 to move in the third direction, and the mounting base 530 simultaneously drives the first gripper driving member 510, the first connecting block 571, the first pressing plate 572, and the first elastic member 573 to move in the third direction. During the movement, the first gripper driving member 510, the first connecting block 571, the first pressing plate 572, and the first elastic member 573 remain stationary with respect to each other. Then, the first gripper driving member 510 drives the first gripper to contact the flowcell 2000, and the first elastic member 573 provides an elastic allowance, thereby achieving a floating pressing by the first gripper driving member 510 and the first gripper onto the flowcell 2000, thus avoiding damage to the flowcell 2000.

In one embodiment, after the flowcell gripping mechanism 500 places the flowcell 2000 onto the station 10, the flowcell 2000 is adsorbed onto the station 10 by means of vacuum adsorption. For example, the station 10 is provided with an adsorption platform, and the adsorption platform is in communication with a vacuum pump. After the flowcell 2000 is placed on the adsorption platform, the vacuum pump extracts the air from the adsorption platform so that the flowcell 2000 is adsorbed onto the adsorption platform. The arrangement of the first connecting block 571, the first pressing plate 572, and the first elastic member 573 arranged between the first connecting block 571 and the first pressing plate 572 achieves the floating pressing of the flowcell 2000 by the first gripper driving member 510 and the first gripper. This ensures that the flowcell 2000 is not damaged, while further facilitating the successful gripping of the flowcell 2000 by the first gripper.

In some specific embodiments of the present disclosure, referring to FIGS. 1, 6, and 7, the flowcell gripping mechanism 500 further includes a fourth guide rail 561 arranged on the mounting base 530 and a fourth guide block 562 arranged on the fourth guide rail 561. The first connecting block 571 is arranged between the first gripper driving member 510 and the fourth guide block 562.

The direction in which the fourth guide rail 561 is arranged is the same as the third direction. After the first gripper driving member 510 drives the first gripper to contact the flowcell 2000, the first elastic member 573 provides an elastic allowance, and the first gripper driving member 510 moves in a direction away from the flowcell 2000. The first gripper driving member 510, via the first connecting block 571, drives the fourth guide block 562 to move on the fourth guide rail 561. The fourth guide block 562 cooperates with the fourth guide rail 561 to provide a guiding effect for the first gripper driving member 510, thereby ensuring the movement accuracy of the first gripper driving member 510. In addition, the arrangement of the fourth guide block 562 and the fourth guide rail 561 can ensure that the first gripper driving member 510, the first gripper, and the first connecting block 571 float in the third direction. Moreover, since the fourth guide rail 561 is arranged on the mounting base 530, the fourth guide rail 561, via the fourth guide block 562, can provide better support for the first gripper driving member 510, the first gripper, and the first connecting block 571.

In some specific embodiments of the present disclosure, referring to FIGS. 1, 6, and 7, the flowcell gripping mechanism 500 further includes a second connecting block 591, a second pressing plate 592, and a second clastic member 593. The second connecting block 591 is arranged on the second gripper driving member 540, the second pressing plate 592 is arranged on the mounting base 530, and the second clastic member 593 is arranged between the second connecting block 591 and the second pressing plate 592.

Specifically, the first pressing plate 572 is arranged on one side of the mounting base 530, and the second pressing plate 592 is arranged on the other side of the mounting base 530.

The second elastic member 593 may include, but is not limited to, a spring, a resilient sheet, a rubber ring, or a rubber sheet.

The third direction motion mechanism 400 drives the mounting base 530 to move in the third direction, and the mounting base 530 simultaneously drives the second gripper driving member 540, the second connecting block 591, the second pressing plate 592, and the second clastic member 593 to move in the third direction. During the movement, the second gripper driving member 540, the second connecting block 591, the second pressing plate 592, and the second clastic member 593 remain stationary with respect to each other. Then, the second gripper driving member 540 drives the second gripper to contact the flowcell 2000, and the second clastic member 593 provides an elastic allowance, thereby achieving a floating pressing by the second gripper driving member 540 and the second gripper onto the flowcell 2000, thus avoiding damage to the flowcell 2000.

In one embodiment, after the flowcell gripping mechanism 500 places the flowcell 2000 onto the station 10, the flowcell 2000 is adsorbed onto the station 10 by means of vacuum adsorption. For example, the station 10 is provided with an adsorption platform, and the adsorption platform is in communication with a vacuum pump. After the flowcell 2000 is placed on the adsorption platform, the vacuum pump extracts the air from the adsorption platform so that the flowcell 2000 is adsorbed onto the adsorption platform. The arrangement of the second connecting block 591, the second pressing plate 592, and the second elastic member 593 arranged between the second connecting block 591 and the second pressing plate 592 achieves the floating pressing of the flowcell 2000 by the second gripper driving member 540 and the second gripper. This ensures that the flowcell 2000 is not damaged, while further facilitating the successful gripping of the flowcell 2000 by the second gripper.

In some specific embodiments of the present disclosure, referring to FIGS. 1, 6, and 7, the flowcell gripping mechanism 500 further includes a fifth guide rail 581 arranged on the other side of the mounting base 530 and a fifth guide block 582 arranged on the fifth guide rail 581.

The second connecting block 591 is arranged between the second gripper driving member 540 and the fifth guide block 582.

The direction in which the fifth guide rail 581 is arranged is the same as the third direction. After the second gripper driving member 540 drives the second gripper to contact the flowcell 2000, the second clastic member 593 provides an elastic allowance, and the second gripper driving member 540 moves in a direction away from the flowcell 2000. The second gripper driving member 540, via the second connecting block 591, drives the fifth guide block 582 to move on the fifth guide rail 581. The fifth guide block 582 cooperates with the fifth guide rail 581 to provide a guiding effect for the second gripper driving member 540, thereby ensuring the movement accuracy of the second gripper driving member 540. In addition, the arrangement of the fifth guide block 582 and the fifth guide rail 581 can ensure that the second gripper driving member 540, the second gripper, and the second connecting block 591 float in the third direction. Moreover, since the fifth guide rail 581 is arranged on the mounting base 530, the fifth guide rail 581, via the fifth guide block 582, can provide better support for the second gripper driving member 540, the second gripper, and the second connecting block 591.

In some specific embodiments of the present disclosure, referring to FIGS. 1, 6, and 7, the flowcell transfer device 1000 further includes a rotation mechanism 600 connected to the third direction motion mechanism 400, and the flowcell gripping mechanism 500 is arranged on the rotation mechanism 600.

Since the second direction motion mechanism 300 is connected to the first direction motion mechanism 200, the first direction motion mechanism 200 drives the second direction motion mechanism 300 to move in the first direction. Since the third direction motion mechanism 400 is connected to the second direction motion mechanism 300, the second direction motion mechanism 300 drives the third direction motion mechanism 400 to move in the first direction. Since the rotation mechanism 600 is connected to the third direction motion mechanism 400, the third direction motion mechanism 400 drives the rotation mechanism 600 to move in the first direction. Since the flowcell gripping mechanism 500 is arranged on the rotation mechanism 600, the rotation mechanism 600 drives the flowcell gripping mechanism 500 to move in the first direction. Since the third direction motion mechanism 400 is connected to the second direction motion mechanism 300, the second direction motion mechanism 300 drives the third direction motion mechanism 400 to move in the second direction. Since the rotation mechanism 600 is connected to the third direction motion mechanism 400, the third direction motion mechanism 400 drives the rotation mechanism 600 to move in the second direction. Since the flowcell gripping mechanism 500 is arranged on the rotation mechanism 600, the rotation mechanism 600 drives the flowcell gripping mechanism 500 to move in the second direction. Since the rotation mechanism 600 is arranged on the third direction motion mechanism 400, the third direction motion mechanism 400 drives the rotation mechanism 600 to move in the third direction. Since the flowcell gripping mechanism 500 is arranged on the rotation mechanism 600, the rotation mechanism 600 drives the flowcell gripping mechanism 500 to move in the third direction. Since the flowcell gripping mechanism 500 is arranged on the rotation mechanism 600, the rotation mechanism 600 drives the flowcell gripping mechanism 500 to rotate.

Under the motion of the first direction motion mechanism 200, the second direction motion mechanism 300, the third direction motion mechanism 400, and the rotation mechanism 600, the flowcell gripping mechanism 500 can be driven to move in the first direction, the second direction, and the third direction, and the flowcell gripping mechanism 500 can be driven to rotate. This achieves multi-dimensional motion of the flowcell gripping mechanism 500, thereby enabling the flowcell gripping mechanism 500 to grip a flowcell 2000 at any station 10 and place the flowcell 2000 at any other station 10. In addition, it can accommodate some scenarios, such as gripping a flowcell 2000 at a certain station 10 and, after changing the orientation of the flowcell 2000 at another certain station 10, placing the flowcell 2000, or such as changing the orientation at a certain station 10 before gripping a flowcell 2000 and placing the flowcell 2000 at another certain station 10.

Furthermore, when two sets of gripper mechanisms are used in the flowcell gripping mechanism 500, the mounting base 530 is arranged on the rotation mechanism 600. When the rotation mechanism 600 rotates, the rotation mechanism 600 drives the mounting base 530 to rotate. The mounting base 530, using itself as the center, drives the two sets of gripper mechanisms to rotate, which makes the two sets of gripper mechanisms more flexible. This can further shorten the movement path, reduce the time for gripping and placing the flowcell 2000, and greatly improve efficiency.

In some specific embodiments of the present disclosure, referring to FIGS. 1, 6, and 7, the rotation mechanism 600 includes a rotation driving member 610 and a connecting seat 620. The rotation driving member 610 is connected to the third direction motion mechanism 400, the connecting seat 620 is connected to the rotation driving member 610, and the flowcell gripping mechanism 500 is arranged on the connecting seat 620.

The rotation driving member 610 is connected to the third direction motion mechanism 400. Specifically, the movable seat 422 has a square structure that is vertically open from top to bottom, surrounding the rotation driving member 610. The movable seat 422 provides support for the rotation driving member 610 and can provide a certain degree of protection for the rotation driving member 610.

The rotation driving member 610 can drive the connecting seat 620 to rotate. If the rotation driving member 610 is a rotation motor, the output shaft of the rotation motor is connected to the connecting seat 620. When the rotation motor operates, the connecting seat 620 is driven to rotate via the output shaft.

When the connecting seat 620 rotates, since the flowcell gripping mechanism 500 is arranged on the connecting seat 620, the connecting seat 620 drives the flowcell gripping mechanism 500 to rotate.

Furthermore, when two sets of gripper mechanisms are used in the flowcell gripping mechanism 500, the mounting base 530 is arranged on the connecting seat 620. When the rotation driving member 610 drives the connecting seat 620 to rotate, the connecting seat 620 drives the mounting base 530 to rotate. The mounting base 530, using itself as the center, drives the two sets of gripper mechanisms to rotate, which makes the two sets of gripper mechanisms more flexible. This can further shorten the movement path, reduce the time for gripping and placing the flowcell 2000, and greatly improve efficiency.

In some specific embodiments of the present disclosure, referring to FIGS. 1, 6, and 7, the output shaft of the rotation driving member 610 is provided with a driving gear 631. The rotation mechanism 600 further includes a driven gear 632, which meshes with the driving gear 631 and is coaxially arranged with the connecting seat 620.

When the rotation driving member 610 operates, the rotation driving member 610 drives the driven gear 632 to rotate via the driving gear 631. Since the connecting seat 620 is arranged on the driven gear 632, the driven gear 632 drives the connecting seat 620 to rotate. Since the flowcell gripping mechanism 500 is arranged on the connecting seat 620, the connecting seat 620 drives the flowcell gripping mechanism 500 to rotate.

In some specific embodiments of the present disclosure, the rotation mechanism 600 further includes a driving gear connected to the output shaft of the rotation driving member 610, as well as a driven gear 632 that meshes with the driving gear and is coaxially arranged with the connecting scat 620.

When the rotation driving member 610 operates, the rotation driving member 610 drives the driving gear to rotate. Since the driving gear meshes with the driven gear 632, the driving gear drives the driven gear 632 to rotate. Since the connecting seat 620 is arranged on the driven gear 632, the driven gear 632 drives the connecting seat 620 to rotate. Since the flowcell gripping mechanism 500 is arranged on the connecting seat 620, the connecting seat 620 drives the flowcell gripping mechanism 500 to rotate.

Referring to FIGS. 1, 11, and 12, a station layout device provided according to the embodiments of the present disclosure cooperates with the flowcell transfer device 1000 according to any one of the above embodiments. The station layout device includes at least one first station platform, and the first station platform is provided with at least one biochemical station 12, at least one imaging station 11, at least one loading station 13, and at least one cleaning station 15. The station layout device further includes at least one second station platform or a bin, and the second station platform or the bin is provided with at least one recycling station 14.

One first station platform may be provided, and at least one biochemical station 12, at least one imaging station 11, at least one loading station 13, and at least one cleaning station 15 are all arranged on the first station platform.

A plurality of first station platforms may be provided. The number of first station platforms is consistent with the total number of biochemical stations 12, imaging stations 11, loading stations 13, and cleaning stations 15, and at least one biochemical station 12, at least one imaging station 11, at least one loading station 13, and at least one cleaning station 15 are respectively arranged on the first station platforms. Alternatively, a plurality of first station platforms may be provided. The number of first station platforms is not consistent with the total number of biochemical stations 12, imaging stations 11, loading stations 13, and cleaning stations 15; some of the plurality of stations 10 are arranged on a single first station platform, and some of the individual stations 10 are arranged on a single first station platform.

The recycling station 14 may be arranged on the second station platform. One second station platform may be provided, and at least one recycling station 14 is arranged on the second station platform. A plurality of second station platforms may be provided, and the number of second station platforms is consistent with the number of recycling stations 14, with the plurality of recycling stations 14 respectively arranged on the second station platforms. Alternatively, a plurality of second station platforms may be provided, and the number of second station platforms is not consistent with the number of recycling stations 14, where at least one recycling station 14 is arranged on a single second station platform.

The recycling station 14 may be arranged on the bin. One bin may be provided, and the recycling station 14 is arranged on the bin. By arranging the recycling station 14 on the bin, the flowcell gripping mechanism 500 can grip an old flowcell 2000, move the flowcell above the bin, and then release the old flowcell 2000, discarding the old flowcell 2000 into the bin.

The first station platform may include a first contact platform 710 and a first support leg 720 arranged below the first contact platform 710. The first contact platform 710 is provided with a first platform surface 711, and the first platform surface 711 is configured for the placement of the flowcell 2000; the first support leg 720 provides support for the first contact platform 710 and can raise the first contact platform 710 so that when the flowcell transfer device 1000 needs to grip or place the flowcell 2000 on the first contact platform 710, the travel distance can be effectively shortened. Alternatively, the first station platform is provided only with the first contact platform 710; the first contact platform 710 is provided with a first platform surface 711, and the first platform surface 711 is configured for the placement of the flowcell 2000.

The second station platform may include a second contact platform and a second support leg arranged below the second contact platform. The second contact platform is provided with a second platform surface, and the second platform surface is configured for the placement of the flowcell 2000; the second support leg provides support for the second contact platform and can raise the second contact platform so that when the flowcell transfer device 1000 needs to grip or place the flowcell 2000 on the second contact platform, the travel distance can be effectively shortened. Alternatively, the second station platform is provided only with the second contact platform; the second contact platform is provided with a second platform surface, and the second platform surface is configured for the placement of the flowcell 2000.

The bin may include a cavity, and when the flowcell gripping mechanism 500 discards an old flowcell 2000, the old flowcell 2000 can fall into the cavity.

The first station platform and the second station platform may be station platforms that are arranged independently of each other, or may be integrated as a single station platform.

In this embodiment, a plurality of flowcells 2000 may be placed at the loading station 13, for example, three flowcells 2000 are placed at the loading station 13, and a cleaning flowcell 2000 may be placed at the cleaning station 15. The flowcell gripping mechanism 500 grips a first flowcell 2000 at the loading station 13 and places the first flowcell at the biochemical station 12, where the first flowcell 2000 undergoes a biochemical reaction at the biochemical station 12. After the biochemical reaction is completed, the flowcell gripping mechanism 500 then grips the first flowcell 2000 at the biochemical station 12 and places the first flowcell at the imaging station 11, where the first flowcell 2000 undergoes sequencing imaging at the imaging station 11. The flowcell gripping mechanism 500 then grips a cleaning flowcell 2000 at the cleaning station 15 and places the cleaning flowcell at the biochemical station 12 to clean the components of the biochemical station 12, such as a liquid inlet/outlet. After cleaning is completed, the flowcell gripping mechanism 500 then grips the cleaning flowcell 2000 at the biochemical station 12 and places the cleaning flowcell at the cleaning station 15. The flowcell gripping mechanism 500 then grips a second flowcell 2000 at the loading station 13 and places the second flowcell at the biochemical station 12, where the second flowcell 2000 undergoes a biochemical reaction at the biochemical station 12. Alternatively, without cleaning the biochemical station 12, the flowcell gripping mechanism 500 grips the second flowcell 2000 at the loading station 13 and places the second flowcell at the biochemical station 12, where the second flowcell 2000 undergoes a biochemical reaction at the biochemical station 12. When the sequencing imaging on the first flowcell 2000 at the imaging station 11 is completed, the flowcell gripping mechanism 500 then grips the first flowcell 2000 at the imaging station 11 and places the first flowcell at the recycling station 14. When the second flowcell 2000 at the biochemical station 12 completes the biochemical reaction, the flowcell gripping mechanism 500 then grips the second flowcell 2000 at the biochemical station 12 and places the second flowcell at the imaging station 11, where the second flowcell 2000 undergoes sequencing imaging at the imaging station 11. The flowcell gripping mechanism 500 then grips the cleaning flowcell 2000 at the cleaning station 15 and places the cleaning flowcell at the biochemical station 12. After cleaning is completed, the flowcell gripping mechanism 500 then grips the cleaning flowcell 2000 at the biochemical station 12 and places the cleaning flowcell at the cleaning station 15. The flowcell gripping mechanism 500 then grips a third flowcell 2000 at the loading station 13 and places the third flowcell at the biochemical station 12, where the third flowcell 2000 undergoes a biochemical reaction at the biochemical station 12. Alternatively, without cleaning the biochemical station 12, the flowcell gripping mechanism 500 grips the third flowcell 2000 at the loading station 13 and places the third flowcell at the biochemical station 12, where the third flowcell 2000 undergoes a biochemical reaction at the biochemical station 12. When the sequencing imaging on the second flowcell 2000 at the imaging station 11 is completed, the flowcell gripping mechanism 500 then grips the second flowcell 2000 at the imaging station 11 and places the second flowcell at the recycling station 14. When the third flowcell 2000 at the biochemical station 12 completes the biochemical reaction, the flowcell gripping mechanism 500 then grips the third flowcell 2000 at the biochemical station 12 and places the third flowcell at the imaging station 11. When the sequencing imaging on the third flowcell 2000 at the imaging station 11 is completed, the flowcell gripping mechanism 500 then grips the third flowcell 2000 at the imaging station 11 and places the third flowcell at the recycling station 14. During the sequencing of the plurality of flowcells 2000, the flowcell gripping mechanism 500 transfers flowcells 2000 among different stations 10, enabling orderly transfer of each flowcell 2000. Duc to the arrangement of multiple stations 10, the simultaneous operation of multiple flowcells 2000 at multiple stations 10 can be achieved, for example, one of the flowcells 2000 is undergoing a biochemical reaction while another flowcell 2000 is simultaneously undergoing sequencing imaging, thereby effectively improving sequencing efficiency.

After the flowcell 2000 completes one cycle−completing the biochemical reaction at the biochemical station 12 and then transferring to the imaging station 11 for sequencing imaging—there may be a situation where the entire sequencing is not yet finished, for example, only sequencing for cycles 1-10 has been performed, and sequencing for cycles 11-20 is still required. The flowcell gripping mechanism 500 needs to grip the cleaning flowcell 2000 from the cleaning station 15 and transfer the cleaning flowcell to the biochemical station 12 for cleaning. After that, the flowcell 2000 is transferred from the imaging station 11 to the biochemical station 12. Alternatively, without cleaning the biochemical station 12, the flowcell 2000 is transferred from the imaging station 11 to the biochemical station 12, followed by a biochemical reaction. After the biochemical reaction is completed, the flowcell is again transferred to the imaging station 11 for sequencing imaging. After the flowcell 2000 completes the entire sequencing, the flowcell gripping mechanism 500 then transfers the flowcell 2000 from the imaging station 11 to the recycling station 14. Further, after the flowcell 2000 is transferred from the biochemical station 12 to the imaging station 11 for the last time, the flowcell gripping mechanism 500 grips the cleaning flowcell 2000 from the cleaning station 15 and transfers the cleaning flowcell to the biochemical station 12 for cleaning, and grips the next flowcell 2000 from the loading station 13 and transfers the flowcell to the biochemical station.

Furthermore, a plurality of biochemical stations 12 may be arranged, allowing a plurality of flowcells 2000 to undergo biochemical reactions at their respective biochemical stations 12. As a specific implementation, for a flowcell 2000 that requires a biochemical reaction, when a biochemical station 12 is in an idle state (no flowcell 2000 is undergoing a biochemical reaction at the biochemical station 12), and if the biochemical station 12 has not previously performed a biochemical reaction, the flowcell gripping mechanism 500 transfers the flowcell 2000 that requires a biochemical reaction to the idle biochemical station 12 for the biochemical reaction. If the biochemical station 12 has previously performed a biochemical reaction, the flowcell gripping mechanism 500 transfers a cleaning flowcell 2000 from the cleaning station 15 to the biochemical station 12 for cleaning. After the cleaning is completed, the flowcell 2000 that requires a biochemical reaction is transferred to the biochemical station 12 for the biochemical reaction. Alternatively, without cleaning the biochemical station 12, the flowcell 2000 that requires a biochemical reaction is transferred to the biochemical station 12 to undergo the biochemical reaction. A plurality of imaging stations 11 may be arranged, allowing a plurality of flowcells 2000 to undergo sequencing imaging at their respective imaging stations 11. As a specific implementation, for a flowcell 2000 that requires sequencing imaging, when an imaging station 11 is in an idle state (no flowcell 2000 is undergoing sequencing imaging at the imaging station 11), the flowcell gripping mechanism 500 transfers the flowcell 2000 that requires sequencing imaging to the idle imaging station 11 for sequencing imaging. A plurality of cleaning flowcells 2000 may be placed on the cleaning station 15. Alternatively, a plurality of cleaning stations 15 may be arranged, and one cleaning flowcell 2000 is placed on each cleaning station 15, thereby facilitating the flowcell gripping mechanism 500 in transferring each cleaning flowcell 2000 to the biochemical station 12 that requires cleaning. As a specific implementation, for a biochemical station 12 that requires cleaning, when there is a cleaning flowcell 2000 at the cleaning station 15, the flowcell gripping mechanism 500 transfers the cleaning flowcell 2000 to the biochemical station 12 that requires cleaning, so as to clean the biochemical station 12. According to the above implementation, the arrangement of more biochemical stations 12, more imaging stations 11, and/or more cleaning flowcells 2000 can achieve more simultaneous sequencing processes, such as multiple biochemical reaction processes, multiple sequencing imaging processes, and/or multiple cleaning processes, thereby further improving sequencing efficiency.

In some specific embodiments of the present disclosure, referring to FIGS. 1 and 12, the first station platform is further provided with at least one emergency station 16.

By arranging the emergency station 16, in the event of a special situation, such as when a flowcell 2000 undergoing a biochemical reaction at the biochemical station 12 encounters a problem and the biochemical reaction cannot proceed smoothly, the flowcell gripping mechanism 500 can transfer the flowcell 2000 from the biochemical station 12 to the emergency station 16. After troubleshooting, the flowcell gripping mechanism 500 can then transfer the flowcell 2000 from the emergency station 16 to the biochemical station 12. Alternatively, the biochemical station 12 is abandoned first, and after the batch of flowcells 2000 has completed sequencing, troubleshooting is then performed on the biochemical station 12.

In some specific embodiments of the present disclosure, referring to FIGS. 1 and 12, a plurality of biochemical stations 12 are provided, and each biochemical station 12 and the imaging station 11 are sequentially arranged along a first straight line from left to right or from right to left.

The arrangement of a plurality of biochemical stations 12 can satisfy the requirement of simultaneous biochemical reactions for a plurality of flowcells 2000, thereby making full use of each station 10 to avoid resource waste and effectively improve efficiency.

Exemplarily, four biochemical stations 12 are provided, and one imaging station 11 is provided. The four biochemical stations 12 and the one imaging station 11 are arranged in the first straight line. The four biochemical stations 12 are sequentially arranged from right to left and are respectively biochemical stations 12a, 12b, 12c, and 12d. The one imaging station 11 is located on one side of the biochemical station 12a. The flowcell gripping mechanism 500 first sequentially transfers the four flowcells 2000 located at the loading station 13 to the biochemical stations 12a, 12b, 12c, and 12d. After the flowcell 2000 at the biochemical station 12a completes the biochemical reaction, the flowcell 2000 at the biochemical station 12a is transferred to the imaging station 11, with the biochemical station 12a being in an idle state. After the sequencing imaging on the flowcell 2000 at the imaging station 11 is completed, the flowcell 2000 at the imaging station 11 is transferred to the recycling station 14. After the flowcell 2000 at the biochemical station 12b completes the biochemical reaction, the flowcell 2000 at the biochemical station 12b is transferred to the imaging station 11, with the biochemical station 12b being in an idle state. After the sequencing imaging on the flowcell 2000 at the imaging station 11 is completed, the flowcell 2000 at the imaging station 11 is transferred to the recycling station 14. After the flowcell 2000 at the biochemical station 12c completes the biochemical reaction, the flowcell 2000 at the biochemical station 12c is transferred to the imaging station 11, with the biochemical station 12c being in an idle state. After the sequencing imaging on the flowcell 2000 at the imaging station 11 is completed, the flowcell 2000 at the imaging station 11 is transferred to the recycling station 14. After the flowcell 2000 at the biochemical station 12d completes the biochemical reaction, the flowcell 2000 at the biochemical station 12d is transferred to the imaging station 11, with the biochemical station 12d being in an idle state. After the sequencing imaging on the flowcell 2000 at the imaging station 11 is completed, the flowcell 2000 at the imaging station 11 is transferred to the recycling station 14. Ultimately, the sequencing of all flowcells 2000 is completed. In this process, each station 10 can be fully utilized to avoid resource waste and effectively improve efficiency. If, after the sequencing imaging on the flowcell 2000 at the imaging station 11 is completed, the flowcell 2000 has not yet completed the entire sequencing, and one biochemical station 12 among the biochemical stations 12a, 12b, 12c, and 12d is in an idle state, then after cleaning, the flowcell 2000 at the imaging station 11 is transferred to the biochemical station 12 to continue the biochemical reaction, and after the biochemical reaction is completed, the flowcell is transferred again to the imaging station 11 for sequencing imaging. Alternatively, without cleaning the biochemical station 12, the flowcell 2000 at the imaging station 11 is transferred to the biochemical station 12 to continue the biochemical reaction, and after the biochemical reaction is completed, the flowcell is again transferred to the imaging station 11 to perform sequencing imaging. If, after the sequencing imaging on the flowcell 2000 at the imaging station 11 is completed, the flowcell 2000 has completed the entire sequencing, then the flowcell gripping mechanism 500 transfers the flowcell 2000 from imaging station 11 to the recycling station 14.

Since typically, the flowcell 2000 needs to undergo sequencing imaging after the biochemical reaction, arranging the biochemical station 12 and the imaging station 11 in a first straight line can effectively shorten the movement path of the flowcell gripping mechanism 500. In addition, with the imaging station 11 arranged at the edge-most position of the first straight line, compared with the imaging station 11 being arranged at the middle position of the first straight line, it is possible to avoid the situation in which the flowcell gripping mechanism 500 needs to move to the biochemical station 12 at the edge-most position to grip the flowcell 2000 and then move to the imaging station 11 at the middle position to place the flowcell 2000. This can further shorten the movement path of the flowcell gripping mechanism 500 and facilitate the layout of the biochemical system for the biochemical reaction of the flowcell 2000 and the imaging system for sequencing imaging of the flowcell 2000. In summary, the biochemical station 12 and the imaging station 11 are arranged in a first straight line, and the imaging station 11 is arranged at the edge-most position of the first straight line, making the station 10 layout more reasonable. This can not only shorten the movement path of the flowcell gripping mechanism 500 and save transfer time for the flowcell 2000, but also facilitate the layout of surrounding systems, such as the biochemical system and the imaging system.

In some specific embodiments of the present disclosure, referring to FIGS. 1 and 12, the loading station 13 and the recycling station 14 are arranged in a second straight line, and the cleaning station 15 and the emergency station 16 are arranged in a third straight line. The second straight line and the third straight line are respectively located on both sides of the first straight line. Additionally, the loading station 13 and the recycling station 14 are arranged at positions near the compartment door of the sequencing system.

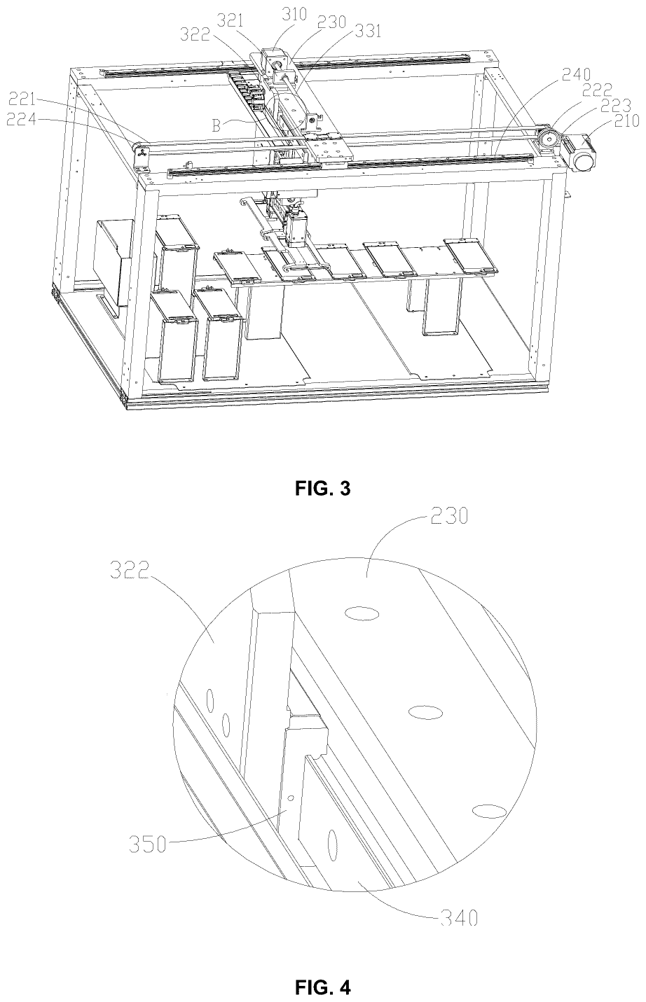

It should be noted that although the frame 100 shown in FIGS. 1 and 3 is open on all sides, in actual scenarios, an enclosure is arranged around all sides of the frame 100 to prevent the external environment from affecting the internal environment. Exemplarily, an automatically or manually openable compartment door is provided on the enclosure. After the compartment door is opened, a new flowcell 2000 can be added at the loading station 13, and an old flowcell 2000 can be collected at the recycling station 14. Therefore, arranging the loading station 13 and the recycling station 14 near the compartment door is conducive to the operations of adding and recycling flowcells 2000.

The loading station 13 and the recycling station 14 are arranged in a second straight line, and the cleaning station 15 and the emergency station 16 are arranged in a third straight line. The second straight line and the third straight line are respectively located on both sides of the first straight line. Compared to arranging all stations 10 in a single straight line, such an arrangement can save space occupied by the stations 10 and prevent the volume of the complete machine from becoming excessive. Moreover, the periphery of the loading station 13, the recycling station 14, the cleaning station 15, and the emergency station 16 usually does not require peripheral system arrangements, whereas the periphery of the biochemical station 12 and the imaging station 11 requires peripheral system arrangements. Thus, on one side or both sides of the biochemical station 12, a biochemical system may be arranged, and on one side or both sides of the imaging station 11, an imaging system may be arranged. In this manner, the station 10 layout is more reasonable and can make full use of the space within the internal environment.

Furthermore, when the flowcell gripping mechanism 500 adopts two sets of gripper mechanisms, the loading station 13 and the recycling station 14, as well as the cleaning station 15 and the emergency station 16, are respectively located on both sides of the biochemical station 12 and the imaging station 11. The flowcell gripping mechanism 500, after gripping the flowcell 2000 at the biochemical station 12 or the imaging station 11, can move only in one dimension, for example, in the first direction, to grip the flowcell 2000 at the loading station 13, the recycling station 14, the cleaning station 15, or the emergency station 16. When a rotation mechanism 600 is further provided, the movement of the flowcell gripping mechanism 500 can be more flexible. For example, after the flowcell gripping mechanism 500 grips the flowcell 2000 at the biochemical station 12 or the imaging station 11, if the other set of gripper mechanism is located on the second straight line where the loading station 13 and the recycling station 14 are located, but needs to move to the cleaning station 15 to grip the cleaning flowcell 2000, the rotation mechanism 600 only needs to drive the flowcell gripping mechanism 500 to rotate by 180° and then move in a certain dimension, such as the first direction, to grip the cleaning flowcell 2000 at the cleaning station 15.

In this embodiment, since the emergency station 16 is used in relatively few situations, the emergency station 16 is farther from the biochemical station 12 and the imaging station 11 than the cleaning station 15. It can be understood that the emergency station 16 is located at the corner position among all the stations 10. Such an arrangement facilitates the flowcell gripping mechanism 500 in gripping and placing the cleaning flowcell 2000 at the cleaning station 15, and can further shorten the movement path of the flowcell gripping mechanism 500.

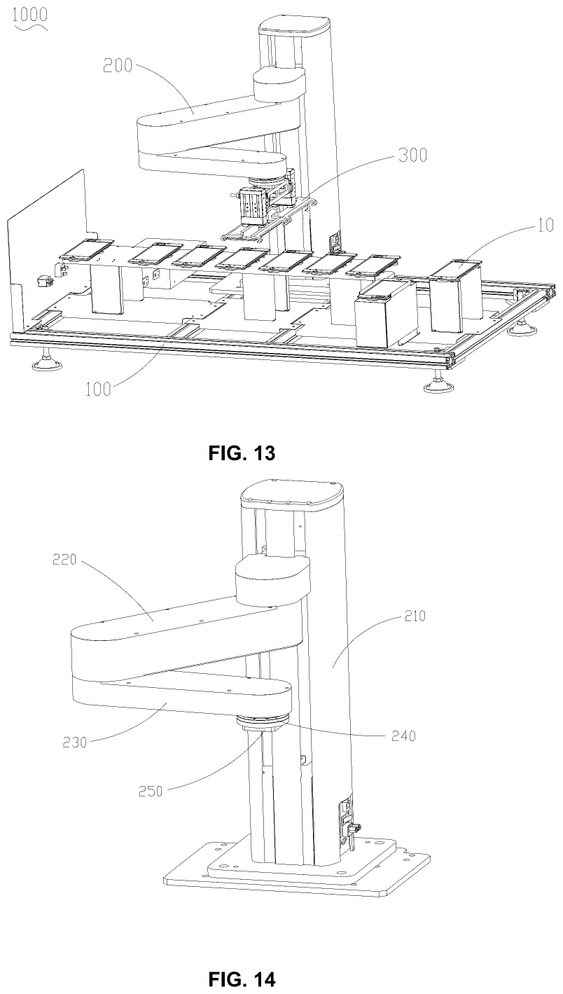

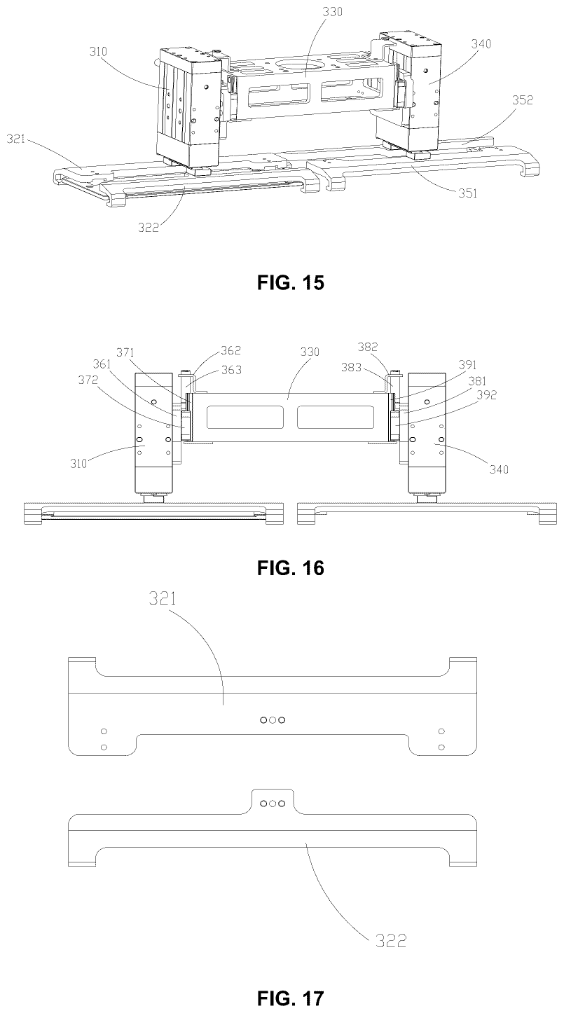

Referring to FIGS. 13 to 16, a flowcell transfer device 1000 provided according to the embodiments of the present disclosure is used in a sequencing system. The flowcell transfer device 1000 includes a multi-dimensional motion mechanism and a flowcell gripping mechanism 300. The multi-dimensional motion mechanism is a multi-axis mechanical arm 200, and the flowcell gripping mechanism 300 is arranged on the multi-axis mechanical arm 200. The multi-axis mechanical arm 200 can drive the flowcell gripping mechanism 300 to move so as to achieve multi-dimensional movement, such that the flowcell gripping mechanism 300 is capable of gripping a flowcell 2000 at any station 10 and placing the flowcell 2000 at any other station 10.

The flowcell gripping mechanism 300 includes a first gripper driving member 310 and a first gripper. The first gripper driving member 310 is arranged on the multi-axis mechanical arm 200, and the first gripper is connected to the first gripper driving member 310. The first gripper includes oppositely arranged first jaw 321 and second jaw 322. Driven by the first gripper driving member 310, the first jaw 321 and the second jaw 322 move toward or away from each other to grip or place the flowcell 2000.

The sequencing system may be a sequencer. The sequencer includes a control device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. Alternatively, the sequencing system may be an integrated system combining a sequencer and a server. The sequencer includes a control device, a communication device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. The control device then controls the communication device to send the sequencing data to the server, and the server stores and/or processes the sequencing data.

The flowcell transfer device 1000 further includes one frame 100, with the multi-axis mechanical arm 200 arranged on the frame 100. The frame 100 provides support for the multi-axis mechanical arm 200.

The multi-axis mechanical arm 200 includes a lifting shaft 210, a first rotating shaft 220, and a second rotating shaft 230. The lifting shaft 210 may be arranged vertically, with one end of the first rotating shaft 220 connected to the lifting shaft 210, and the other end of the first rotating shaft 220 connected to one end of the second rotating shaft 230. The other end of the second rotating shaft 230 is connected to the flowcell gripping mechanism 300.

The lifting shaft 210 can drive the first rotating shaft 220 to move up and down. Since the second rotating shaft 230 is connected to the first rotating shaft 220, the first rotating shaft 220 drives the second rotating shaft 230 to move up and down. Since the flowcell gripping mechanism 300 is connected to the second rotating shaft 230, the second rotating shaft 230 drives the flowcell gripping mechanism 300 to move up and down. The first rotating shaft 220 can use the lifting shaft 210 as a pivot point, rotating about the portion connected to the lifting shaft 210. Since the second rotating shaft 230 is connected to the first rotating shaft 220, the first rotating shaft 220 drives the second rotating shaft 230 to move. Since the flowcell gripping mechanism 300 is connected to the second rotating shaft 230, the second rotating shaft 230 drives the flowcell gripping mechanism 300 to move. The second rotating shaft 230 can use the first rotating shaft 220 as a pivot point, rotating about the portion connected to the first rotating shaft 220. Since the flowcell gripping mechanism 300 is connected to the second rotating shaft 230, the second rotating shaft 230 drives the flowcell gripping mechanism 300 to move.

For the multi-axis mechanical arm 200, each motion is independently controlled, and the multi-axis mechanical arm can perform at least one of the following actions: the lifting shaft 210 driving the first rotating shaft 220 to move up and down, the first rotating shaft 220 rotating, or the second rotating shaft 230 rotating. For example, (1) only performing the action of the lifting shaft 210 driving the first rotating shaft 220 to move up and down; (2) only performing the action of the first rotating shaft 220 rotating; 3 only performing the action of the second rotating shaft 230 rotating; 4) simultaneously performing the actions of the lifting shaft 210 driving the first rotating shaft 220 to move up and down and the first rotating shaft 220 rotating; 5 simultaneously performing the actions of the lifting shaft 210 driving the first rotating shaft 220 to move up and down and the second rotating shaft 230 rotating; 6 simultaneously performing the actions of the first rotating shaft 220 rotating and the second rotating shaft 230 rotating; 7 simultaneously performing the actions of the lifting shaft 210 driving the first rotating shaft 220 to move up and down, the first rotating shaft 220 rotating, and the second rotating shaft 230 rotating. By executing the above actions, the multi-axis mechanical arm 200 can drive the flowcell gripping mechanism 300 to move to the positions of the various stations 10, such that the flowcell gripping mechanism 300 can grip a flowcell 2000 at any station 10 and place the flowcell 2000 at any other station 10.

Driven by the multi-axis mechanical arm 200, the flowcell gripping mechanism 300 can be moved to the positions of the various stations 10, such that the flowcell gripping mechanism 300 can grip a flowcell 2000 at any station 10 and place the flowcell 2000 at any other station 10. For example, the station 10 includes a loading station 13, a biochemical station 12, an imaging station 11, a cleaning station 15, and a recycling station 14. A plurality of flowcells 2000 may be placed at the loading station 13, for example, three flowcells 2000 are placed at the loading station 13, and a cleaning flowcell 2000 may be placed at the cleaning station 15. The cleaning flowcell 2000 may be identical to the flowcell 2000, but since the cleaning flowcell 2000 only serves a cleaning function without biochemical reaction or sequencing imaging, it is referred to as the cleaning flowcell 2000. The flowcell gripping mechanism 300 grips a first flowcell 2000 at the loading station 13 and places the first flowcell at the biochemical station 12, where the first flowcell 2000 undergoes a biochemical reaction at the biochemical station 12.

After the biochemical reaction is completed, the flowcell gripping mechanism 300 then grips the first flowcell 2000 at the biochemical station 12 and places the first flowcell at the imaging station 11, where the first flowcell 2000 undergoes sequencing imaging at the imaging station 11. The flowcell gripping mechanism 300 then grips a cleaning flowcell 2000 at the cleaning station 15 and places the cleaning flowcell at the biochemical station 12 to clean the components of the biochemical station 12, such as a liquid inlet/outlet. After cleaning is completed, the flowcell gripping mechanism 300 then grips the cleaning flowcell 2000 at the biochemical station 12 and places the cleaning flowcell at the cleaning station 15. The flowcell gripping mechanism 300 then grips a second flowcell 2000 at the loading station 13 and places the second flowcell at the biochemical station 12, where the second flowcell 2000 undergoes a biochemical reaction at the biochemical station 12. Alternatively, without cleaning the biochemical station 12, the flowcell gripping mechanism 300 grips the second flowcell 2000 at the loading station 13 and places the second flowcell at the biochemical station 12, where the second flowcell 2000 undergoes a biochemical reaction at the biochemical station 12. When the sequencing imaging on the first flowcell 2000 at the imaging station 11 is completed, the flowcell gripping mechanism 300 then grips the first flowcell 2000 at the imaging station 11 and places the first flowcell at the recycling station 14. When the second flowcell 2000 at the biochemical station 12 completes the biochemical reaction, the flowcell gripping mechanism 300 then grips the second flowcell 2000 at the biochemical station 12 and places the second flowcell at the imaging station 11, where the second flowcell 2000 undergoes sequencing imaging at the imaging station 11. The flowcell gripping mechanism 300 then grips the cleaning flowcell 2000 at the cleaning station 15 and places the cleaning flowcell at the biochemical station 12. After cleaning is completed, the flowcell gripping mechanism 300 then grips the cleaning flowcell 2000 at the biochemical station 12 and places the cleaning flowcell at the cleaning station 15. The flowcell gripping mechanism 300 then grips a third flowcell 2000 at the loading station 13 and places the third flowcell at the biochemical station 12, where the third flowcell 2000 undergoes a biochemical reaction at the biochemical station 12. Alternatively, without cleaning the biochemical station 12, the flowcell gripping mechanism 300 grips the third flowcell 2000 at the loading station 13 and places the third flowcell at the biochemical station 12, where the third flowcell 2000 undergoes a biochemical reaction at the biochemical station 12. When the sequencing imaging on the second flowcell 2000 at the imaging station 11 is completed, the flowcell gripping mechanism 300 then grips the second flowcell 2000 at the imaging station 11 and places the second flowcell at the recycling station 14. When the third flowcell 2000 at the biochemical station 12 completes the biochemical reaction, the flowcell gripping mechanism 300 then grips the third flowcell 2000 at the biochemical station 12 and places the third flowcell at the imaging station 11. When the sequencing imaging on the third flowcell 2000 at the imaging station 11 is completed, the flowcell gripping mechanism 300 then grips the third flowcell 2000 at the imaging station 11 and places the third flowcell at the recycling station 14. During the sequencing of the plurality of flowcells 2000, the flowcell gripping mechanism 300 transfers flowcells 2000 among different stations 10, enabling orderly transfer of each flowcell 2000. Due to the arrangement of multiple stations 10, the simultaneous operation of multiple flowcells 2000 at multiple stations 10 can be achieved, for example, one of the flowcells 2000 is undergoing a biochemical reaction while another flowcell 2000 is simultaneously undergoing sequencing imaging, thereby effectively improving sequencing efficiency.

After the flowcell 2000 completes one cycle—completing the biochemical reaction at the biochemical station 12 and then transferring to the imaging station 11 for sequencing imaging—there may be a situation where the entire sequencing is not yet finished, for example, only sequencing for cycles 1-10 has been performed, and sequencing for cycles 11-20 is still required. The flowcell gripping mechanism 300 needs to grip the cleaning flowcell 2000 from the cleaning station 15 and transfer the cleaning flowcell to the biochemical station 12 for cleaning. After that, the flowcell 2000 is transferred from the imaging station 11 to the biochemical station 12. Alternatively, without cleaning the biochemical station 12, the flowcell 2000 is transferred from the imaging station 11 to the biochemical station 12, followed by a biochemical reaction. After the biochemical reaction is completed, the flowcell is again transferred to the imaging station 11 for sequencing imaging. After the flowcell 2000 completes the entire sequencing, the flowcell gripping mechanism 300 then transfers the flowcell 2000 from the imaging station 11 to the recycling station 14. Further, after the flowcell 2000 is transferred from the biochemical station 12 to the imaging station 11 for the last time, the flowcell gripping mechanism 300 grips the cleaning flowcell 2000 from the cleaning station 15 and transfers the cleaning flowcell to the biochemical station 12 for cleaning, and grips the next flowcell 2000 from the loading station 13 and transfers the flowcell to the biochemical station.

Furthermore, a plurality of biochemical stations 12 may be arranged, allowing a plurality of flowcells 2000 to undergo biochemical reactions at their respective biochemical stations 12. As a specific implementation, for a flowcell 2000 that requires a biochemical reaction, when a biochemical station 12 is in an idle state (no flowcell 2000 is undergoing a biochemical reaction at the biochemical station 12), and if the biochemical station 12 has not previously performed a biochemical reaction, the flowcell gripping mechanism 300 transfers the flowcell 2000 that requires a biochemical reaction to the idle biochemical station 12 for the biochemical reaction. If the biochemical station 12 has previously performed a biochemical reaction, the flowcell gripping mechanism 300 transfers a cleaning flowcell 2000 from the cleaning station 15 to the biochemical station 12 for cleaning. After the cleaning is completed, the flowcell 2000 that requires a biochemical reaction is transferred to the biochemical station 12 for the biochemical reaction. Alternatively, without cleaning the biochemical station 12, the flowcell 2000 that requires a biochemical reaction is transferred to the biochemical station 12 to undergo the biochemical reaction. A plurality of imaging stations 11 may be arranged, allowing a plurality of flowcells 2000 to undergo sequencing imaging at their respective imaging stations 11. As a specific implementation, for a flowcell 2000 that requires sequencing imaging, when an imaging station 11 is in an idle state (no flowcell 2000 is undergoing sequencing imaging at the imaging station 11), the flowcell gripping mechanism 300 transfers the flowcell 2000 that requires sequencing imaging to the idle imaging station 11 for sequencing imaging. A plurality of cleaning flowcells 2000 may be placed on the cleaning station 15. Alternatively, a plurality of cleaning stations 15 may be arranged, and one cleaning flowcell 2000 is placed on each cleaning station 15, thereby facilitating the flowcell gripping mechanism 300 in transferring each cleaning flowcell 2000 to the biochemical station 12 that requires cleaning. As a specific implementation, for a biochemical station 12 that requires cleaning, when there is a cleaning flowcell 2000 at the cleaning station 15, the flowcell gripping mechanism 300 transfers the cleaning flowcell 2000 to the biochemical station 12 that requires cleaning, so as to clean the biochemical station 12. According to the above implementation, the arrangement of more biochemical stations 12, more imaging stations 11, and/or more cleaning flowcells 2000 can achieve more simultaneous sequencing processes, such as multiple biochemical reaction processes, multiple sequencing imaging processes, and/or multiple cleaning processes, thereby further improving sequencing efficiency.

In this embodiment, an initial position may be set, for example, by setting a position above the loading station 13 as the initial position. After the flowcell gripping mechanism 300 completes one operation of gripping and placing a flowcell 2000, the flowcell gripping mechanism 300 returns to the initial position and waits for the next operation of gripping and placing a flowcell 2000, with the flowcell gripping mechanism 300 starting from the initial position to perform the operation of gripping and placing the flowcell 2000. Alternatively, after each time the flowcell gripping mechanism 300 completes one operation of gripping and placing a flowcell 2000, the multi-axis mechanical arm 200 drives the flowcell gripping mechanism 300 to move, such as moving upward. The flowcell gripping mechanism 300 stops at this position and waits for the next operation of gripping and placing a flowcell 2000, with the flowcell gripping mechanism 300 starting from this position to perform the operation of gripping and placing the flowcell 2000.

The first gripper driving member 310 is arranged on the multi-axis mechanical arm 200; specifically, the first gripper driving member 310 is arranged at the other end of the second rotating shaft 230 (the end away from the joint between the second rotating shaft 230 and the first rotating shaft 220). The multi-axis mechanical arm 200 drives the first gripper driving member 310 to perform multi-dimensional movement. Since the first gripper is connected to the first gripper driving member 310, the first gripper driving member 310 drives the first gripper to perform multi-dimensional movement.

The first jaw 321 is provided with a first claw tip 3211 that curves inward, and the second jaw 322 is provided with a second claw tip 3221 that curves inward. Driven by the first gripper driving member 310, the first jaw 321 and the second jaw 322 move toward each other, such that the flowcell 2000 can be gripped by the first claw tip 3211 and the second claw tip 3221.

Driven by the multi-axis mechanical arm 200, the flowcell gripping mechanism 300 moves to a position above the flowcell 2000 to be gripped. The first gripper driving member 310 drives the first jaw 321 and the second jaw 322 to move away from each other. Next, the multi-axis mechanical arm 200 drives the flowcell gripping mechanism 300 to move, such as moving downward. The first gripper driving member 310 drives the first jaw 321 and the second jaw 322 to move toward each other, such that the flowcell 2000 is gripped by the first claw tip 3211 and the second claw tip 3221. Then, the multi-axis mechanical arm 200 drives the flowcell gripping mechanism 300 to move, such as moving upward, and then the multi-axis mechanical arm 200 drives the flowcell gripping mechanism 300 to move to a position above where the flowcell 2000 is to be placed. Subsequently, the multi-axis mechanical arm 200 drives the flowcell gripping mechanism 300 to move, such as moving downward, and the first gripper driving member 310 drives the first jaw 321 and the second jaw 322 to move away from each other to place the flowcell 2000.

The workflow of the flowcell gripping mechanism 300 is described in conjunction with the station 10.

For example, when the flowcell 2000 at the loading station 13 needs to be transferred to the biochemical station 12, the flowcell gripping mechanism 300, driven by the multi-axis mechanical arm 200, moves to a position above the loading station 13. The first gripper driving member 310 drives the first jaw 321 and the second jaw 322 to move away from each other. Next, the multi-axis mechanical arm 200 drives the flowcell gripping mechanism 300 to move, such as moving downward, and the first gripper driving member 310 drives the first jaw 321 and the second jaw 322 to move toward each other, such that the flowcell 2000 is gripped by the first claw tip 3211 and the second claw tip 3221. Then, the multi-axis mechanical arm 200 drives the flowcell gripping mechanism 300 to move, such as moving upward, and then the multi-axis mechanical arm 200 drives the flowcell gripping mechanism 300 to move to a position above the biochemical station 12. Subsequently, the multi-axis mechanical arm 200 drives the flowcell gripping mechanism 300 to move, such as moving downward, and the first gripper driving member 310 drives the first jaw 321 and the second jaw 322 to move away from each other, so as to place the flowcell 2000 on the biochemical station 12.

For example, when the flowcell 2000 at the biochemical station 12 needs to be transferred to the imaging station 11, the flowcell gripping mechanism 300, driven by the multi-axis mechanical arm 200, moves to a position above the biochemical station 12. The first gripper driving member 310 drives the first jaw 321 and the second jaw 322 to move away from each other. Next, the multi-axis mechanical arm 200 drives the flowcell gripping mechanism 300 to move, such as moving downward, and the first gripper driving member 310 drives the first jaw 321 and the second jaw 322 to move toward each other, such that the flowcell 2000 is gripped by the first claw tip 3211 and the second claw tip 3221. Then, the multi-axis mechanical arm 200 drives the flowcell gripping mechanism 300 to move, such as moving upward, and then the multi-axis mechanical arm 200 drives the flowcell gripping mechanism 300 to move to a position above the imaging station 11. Subsequently, the multi-axis mechanical arm 200 drives the flowcell gripping mechanism 300 to move, such as moving downward, and the first gripper driving member 310 drives the first jaw 321 and the second jaw 322 to move away from each other, so as to place the flowcell 2000 on the imaging station 11.

For example, when the flowcell 2000 at the imaging station 11 needs to be transferred to the recycling station 14, the flowcell gripping mechanism 300, driven by the multi-axis mechanical arm 200, moves to a position above the imaging station 11. The first gripper driving member 310 drives the first jaw 321 and the second jaw 322 to move away from each other. Next, the multi-axis mechanical arm 200 drives the flowcell gripping mechanism 300 to move, such as moving downward, and the first gripper driving member 310 drives the first jaw 321 and the second jaw 322 to move toward each other, such that the flowcell 2000 is gripped by the first claw tip 3211 and the second claw tip 3221. Then, the multi-axis mechanical arm 200 drives the flowcell gripping mechanism 300 to move, such as moving upward, and then the multi-axis mechanical arm 200 drives the flowcell gripping mechanism 300 to move to a position above the recycling station 14. Subsequently, the multi-axis mechanical arm 200 drives the flowcell gripping mechanism 300 to move, such as moving downward, and the first gripper driving member 310 drives the first jaw 321 and the second jaw 322 to move away from each other, so as to place the flowcell 2000 on the recycling station 14.

For example, when the cleaning flowcell 2000 at the cleaning station 15 needs to be transferred to the biochemical station 12, the flowcell gripping mechanism 300, driven by the multi-axis mechanical arm 200, moves to a position above the cleaning station 15. The first gripper driving member 310 drives the first jaw 321 and the second jaw 322 to move away from each other. Next, the multi-axis mechanical arm 200 drives the flowcell gripping mechanism 300 to move, such as moving downward, and the first gripper driving member 310 drives the first jaw 321 and the second jaw 322 to move toward each other, such that the cleaning flowcell 2000 is gripped by the first claw tip 3211 and the second claw tip 3221. Then, the multi-axis mechanical arm 200 drives the flowcell gripping mechanism 300 to move, such as moving upward, and then the multi-axis mechanical arm 200 drives the flowcell gripping mechanism 300 to move to a position above the biochemical station 12. Subsequently, the multi-axis mechanical arm 200 drives the flowcell gripping mechanism 300 to move, such as moving downward, and the first gripper driving member 310 drives the first jaw 321 and the second jaw 322 to move away from each other, so as to place the cleaning flowcell 2000 on the biochemical station 12.

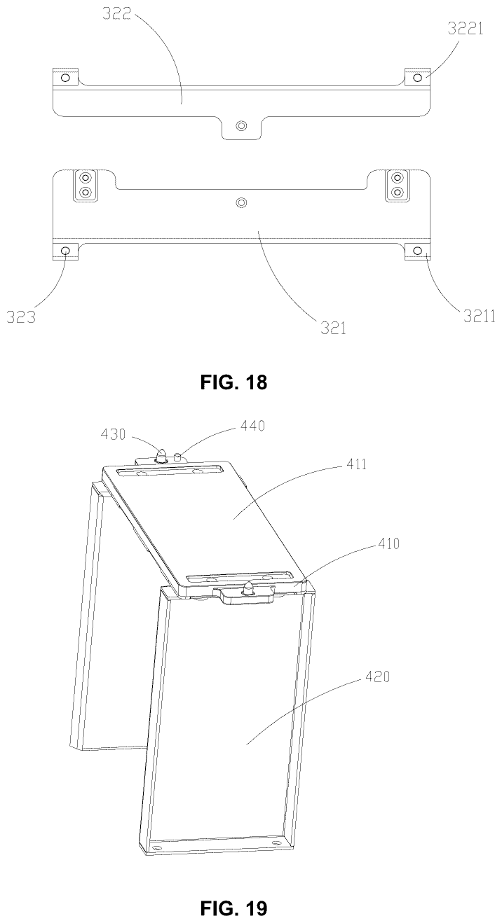

In some specific embodiments of the present disclosure, referring to FIGS. 17 and 18, both the first jaw 321 and the second jaw 322 are provided with a first positioning pin 323. When the first jaw 321 and the second jaw 322 move toward or away from each other, the first positioning pin 323 contacts or moves away from the positioning groove of the flowcell 2000.

In the first jaw 321, the first positioning pin 323 is arranged on the first claw tip 3211; in the second jaw 322, the first positioning pin 323 is arranged on the second claw tip 3221. When the first gripper driving member 310 drives the first jaw 321 and the second jaw 322 to move toward each other, the first positioning pin 323 contacts the positioning groove 2100 of the flowcell 2000, and the first claw tip 3211 and the second claw tip 3221 support the flowcell 2000 from below, thereby achieving gripping of the flowcell 2000. When the first gripper driving member 310 drives the first jaw 321 and the second jaw 322 to move away from each other, the first positioning pin 323 disengages from the positioning groove 2100 of the flowcell 2000, thereby achieving placement of the flowcell 2000. The arrangement of the first positioning pin 323 satisfies the accuracy requirements for gripping the flowcell 2000 and can prevent the flowcell 2000 from falling due to a power failure.

In some specific embodiments of the present disclosure, referring to FIG. 10, the flowcell 2000 is provided with a plurality of positioning grooves 2100, the plurality of positioning grooves 2100 each have either a first shape or a second shape, the first shape being different from the second shape. For example, the flowcell 2000 is provided with positioning grooves 2100 at the four ends thereof. The positioning grooves 2100 located at both ends of one long side of the flowcell 2000 are respectively a rectangular groove and a triangular groove. The positioning grooves 2100 located at both ends of the other long side of the flowcell 2000 are respectively a rectangular groove and a triangular groove. The two rectangular grooves are opposite to each other, and the two triangular grooves are opposite to each other. The arrangement of a plurality of positioning grooves 2100 with different shapes can further improve the gripping accuracy for the flowcell 2000.

In some specific embodiments of the present disclosure, referring to FIG. 10, a positioning hole 2200 and a poka-yoke hole 2300 are provided at both ends of the flowcell 2000. Referring to FIG. 19, the station 10 is provided with the station platform, and the station platform is provided with a positioning shaft 430 that cooperates with the positioning hole 2200 and a poka-yoke shaft 440 that cooperates with the poka-yoke hole 2300. When the flowcell 2000 is placed on the station 10, the positioning shaft 430 is inserted into the positioning hole 2200 to achieve positioning of the flowcell 2000, and the poka-yoke shaft 440 is inserted into the poka-yoke hole 2300 to achieve poka-yoke of the flowcell 2000.

Alternatively, a positioning shaft and a poka-yoke shaft are provided at both ends of the flowcell 2000. The station 10 is provided with a station platform, and the station platform is provided with a positioning hole that cooperates with the positioning shaft and a poka-yoke hole that cooperates with the poka-yoke shaft. When the flowcell 2000 is placed on the station 10, the positioning shaft is inserted into the positioning hole to achieve positioning of the flowcell 2000, and the poka-yoke shaft is inserted into the poka-yoke hole to achieve poka-yoke of the flowcell 2000.

In some specific embodiments of the present disclosure, referring to FIGS. 13, 15, and 16, the multi-axis mechanical arm 200 may also drive the flowcell gripping mechanism 300 to perform a rotational motion. The flowcell gripping mechanism 300 further includes a mounting base 330, a second gripper driving member 340, and a second gripper. The mounting base 330 is connected to the multi-axis mechanical arm 200. The first gripper driving member 310 is arranged on the mounting base 330, and the second gripper driving member 340 is arranged on the mounting base 330. The second gripper is connected to the second gripper driving member 340. The second gripper includes oppositely arranged third jaw 351 and fourth jaw 352. Driven by the second gripper driving member 340, the third jaw 351 and the fourth jaw 352 move toward or away from each other to grip or place the flowcell 2000.

Specifically, the first gripper driving member 310 is arranged on one side of the mounting base 330, and the second gripper driving member 340 is arranged on the other side of the mounting base 330.

The mounting base 330 is connected to the multi-axis mechanical arm 200; specifically, the mounting base 330 is connected to the other end of the second rotating shaft 230 (the end away from the joint between the second rotating shaft 230 and the first rotating shaft 220). The multi-axis mechanical arm 200 drives the mounting base 330 to perform multi-dimensional movement. Since the first gripper driving member 310 and the second gripper driving member 340 are arranged on the mounting base 330, the mounting base 330 drives the first gripper driving member 310 and the second gripper driving member 340 to perform multi-dimensional movement. Since the first gripper is arranged on the first gripper driving member 310, the first gripper driving member 310 drives the first gripper to perform multi-dimensional movement. Since the second gripper is arranged on the second gripper driving member 340, the second gripper driving member 340 drives the second gripper to perform multi-dimensional movement.

The third jaw 351 is provided with a third claw tip that curves inward, and the fourth jaw 352 is provided with a fourth claw tip that curves inward. Driven by the second gripper driving member 340, the third jaw 351 and the fourth jaw 352 move toward each other, such that the flowcell 2000 can be gripped by the first claw tip 3211 and the second claw tip 3221.

Driven by the multi-axis mechanical arm 200, the second gripper driving member 340 moves to a position above the flowcell 2000 to be gripped. The second gripper driving member 340 drives the third jaw 351 and the fourth jaw 352 to move away from each other. Next, the multi-axis mechanical arm 200 drives the second gripper driving member 340 to move, such as moving downward. The second gripper driving member 340 drives the third jaw 351 and the fourth jaw 352 to move toward each other, such that the flowcell 2000 is gripped by the third claw tip and the fourth claw tip. Then, the multi-axis mechanical arm 200 drives the second gripper driving member 340 to move, such as moving upward, and then the multi-axis mechanical arm 200 drives the second gripper driving member 340 to move to a position above where the flowcell 2000 is to be placed. Subsequently, the multi-axis mechanical arm 200 drives the second gripper driving member 340 to move, such as moving downward, and the second gripper driving member 340 drives the third jaw 351 and the fourth jaw 352 to move away from each other to place the flowcell 2000.

The workflow of the second gripper driving member 340 and the second gripper is described in conjunction with the station 10.

For example, when the flowcell 2000 at the loading station 13 needs to be transferred to the biochemical station 12, the second gripper driving member 340, driven by the multi-axis mechanical arm 200, moves to a position above the loading station 13. The second gripper driving member 340 drives the third jaw 351 and the fourth jaw 352 to move away from each other. Next, the multi-axis mechanical arm 200 drives the second gripper driving member 340 to move, such as moving downward, and the second gripper driving member 340 drives the third jaw 351 and the fourth jaw 352 to move toward each other, such that the flowcell 2000 is gripped by the third claw tip and the fourth claw tip. Then, the multi-axis mechanical arm 200 drives the second gripper driving member 340 to move, such as moving upward, and then the multi-axis mechanical arm 200 drives the second gripper driving member 340 to move to a position above the biochemical station 12. Subsequently, the multi-axis mechanical arm 200 drives the second gripper driving member 340 to move, such as moving downward, and the second gripper driving member 340 drives the third jaw 351 and the fourth jaw 352 to move away from each other, so as to place the flowcell 2000 on the biochemical station 12.

For example, when the flowcell 2000 at the biochemical station 12 needs to be transferred to the imaging station 11, the second gripper driving member 340, driven by the multi-axis mechanical arm 200, moves to a position above the biochemical station 12. The second gripper driving member 340 drives the third jaw 351 and the fourth jaw 352 to move away from each other. Next, the multi-axis mechanical arm 200 drives the second gripper driving member 340 to move, such as moving downward, and the second gripper driving member 340 drives the third jaw 351 and the fourth jaw 352 to move toward each other, such that the flowcell 2000 is gripped by the third claw tip and the fourth claw tip. Then, the multi-axis mechanical arm 200 drives the second gripper driving member 340 to move, such as moving upward, and then the multi-axis mechanical arm 200 drives the second gripper driving member 340 to move to a position above the imaging station 11. Subsequently, the multi-axis mechanical arm 200 drives the second gripper driving member 340 to move, such as moving downward, and the second gripper driving member 340 drives the third jaw 351 and the fourth jaw 352 to move away from each other, so as to place the flowcell 2000 on the imaging station 11.

For example, when the flowcell 2000 at the imaging station 11 needs to be transferred to the recycling station 14, the second gripper driving member 340, driven by the multi-axis mechanical arm 200, moves to a position above the imaging station 11. The second gripper driving member 340 drives the third jaw 351 and the fourth jaw 352 to move away from each other. Next, the multi-axis mechanical arm 200 drives the second gripper driving member 340 to move, such as moving downward, and the second gripper driving member 340 drives the third jaw 351 and the fourth jaw 352 to move toward each other, such that the flowcell 2000 is gripped by the third claw tip and the fourth claw tip. Then, the multi-axis mechanical arm 200 drives the second gripper driving member 340 to move, such as moving upward, and then the multi-axis mechanical arm 200 drives the second gripper driving member 340 to move to a position above the recycling station 14. Subsequently, the multi-axis mechanical arm 200 drives the second gripper driving member 340 to move, such as moving downward, and the second gripper driving member 340 drives the third jaw 351 and the fourth jaw 352 to move away from each other, so as to place the flowcell 2000 on the recycling station 14.

For example, when the cleaning flowcell 2000 at the cleaning station 15 needs to be transferred to the biochemical station 12, the second gripper driving member 340, driven by the multi-axis mechanical arm 200, moves to a position above the cleaning station 15. The second gripper driving member 340 drives the third jaw 351 and the fourth jaw 352 to move away from each other. Next, the multi-axis mechanical arm 200 drives the second gripper driving member 340 to move, such as moving downward, and the second gripper driving member 340 drives the third jaw 351 and the fourth jaw 352 to move toward each other, such that the cleaning flowcell 2000 is gripped by the third claw tip and the fourth claw tip. Then, the multi-axis mechanical arm 200 drives the second gripper driving member 340 to move, such as moving upward, and then the multi-axis mechanical arm 200 drives the second gripper driving member 340 to move to a position above the biochemical station 12. Subsequently, the multi-axis mechanical arm 200 drives the second gripper driving member 340 to move, such as moving downward, and the second gripper driving member 340 drives the third jaw 351 and the fourth jaw 352 to move away from each other, so as to place the cleaning flowcell 2000 on the biochemical station 12.

In this embodiment, two sets of gripper mechanisms are provided in the flowcell gripping mechanism 300, which, compared with a single set of gripper mechanisms, expands the application scenarios. For example, one set of gripper mechanism can grip the flowcell 2000, while the other set of gripper mechanism can place the flowcell 2000. Alternatively, the two sets of gripper mechanisms can first grip flowcells 2000 and then sequentially place the flowcells 2000, and so on. This can shorten the movement path of the flowcell gripping mechanism 300, reduce the time for gripping and placing flowcells 2000, and greatly improve efficiency.

Referring to FIG. 14, the other end of the second rotating shaft 230 (the end away from the joint of the second rotating shaft 230 and the first rotating shaft 220) is provided with a rotating member 240. The rotating member 240 is provided with a connecting member 250, and the mounting base 330 is arranged on the connecting member 250. The rotating member 240 rotates; since the connecting member 250 is arranged on the rotating member 240, the rotating member 240 drives the connecting member 250 to rotate. Since the mounting base 330 is arranged on the connecting member 250, the connecting member 250 drives the mounting base 330 to rotate. Since the first gripper driving member 310 and the second gripper driving member 340 are arranged on the mounting base 330, the mounting base 330 drives the first gripper driving member 310 and the second gripper driving member 340 to rotate around the mounting base. Since the first gripper is arranged on the first gripper driving member 310, the first gripper driving member 310 drives the first gripper to rotate around the mounting base 330. Since the second gripper is arranged on the second gripper driving member 340, the second gripper driving member 340 drives the second gripper to rotate around the mounting base 330. When the rotating member 240 rotates, the rotating member 240 drives the mounting base 330 to rotate. The mounting base 330, using itself as the center, drives the two sets of gripper mechanisms to rotate, which makes the two sets of gripper mechanisms more flexible. This can further shorten the movement path, reduce the time for gripping and placing the flowcell 2000, and greatly improve efficiency.

In some specific embodiments of the present disclosure, both the third jaw 351 and the fourth jaw 352 are provided with a second positioning pin. When the third jaw 351 and the fourth jaw 352 move toward or away from each other, the second positioning pin contacts or disengages from the positioning groove of the flowcell 2000.

In the third jaw 351, the second positioning pin is arranged on the third claw tip; in the fourth jaw 352, the second positioning pin is arranged on the fourth claw tip. When the second gripper driving member 340 drives the third jaw 351 and the fourth jaw 352 to move toward each other, the second positioning pin contacts the positioning groove 2100 of the flowcell 2000, and the third claw tip and the fourth claw tip support the flowcell 2000 from below, thereby achieving gripping of the flowcell 2000. When the second gripper driving member 340 drives the third jaw 351 and the fourth jaw 352 to move away from each other, the second positioning pin disengages from the positioning groove 2100 of the flowcell 2000, thereby achieving placement of the flowcell 2000. The arrangement of the second positioning pin satisfies the accuracy requirements for gripping the flowcell 2000 and can prevent the flowcell 2000 from falling due to a power failure.

In some specific embodiments of the present disclosure, referring to FIGS. 13, 15, and 16, the flowcell gripping mechanism 300 further includes a first connecting block 361, a first pressing plate 362, and a first elastic member 363. The first connecting block 361 is arranged on the first gripper driving member 310, the first pressing plate 362 is arranged on the mounting base 330, and the first elastic member 363 is arranged between the first connecting block 361 and the first pressing plate 362.

The first elastic member 363 may include, but is not limited to, a spring, a resilient sheet, a rubber ring, or a rubber sheet.

The multi-axis mechanical arm 200 drives the mounting base 330 to move, such as moving downward, and the mounting base 330 simultaneously drives the first gripper driving member 310, the first connecting block 361, the first pressing plate 362, and the first elastic member 363 to move, such as moving downward. During the movement, the first gripper driving member 310, the first connecting block 361, the first pressing plate 362, and the first elastic member 363 remain stationary with respect to each other. Then, the first gripper driving member 310 drives the first gripper to contact the flowcell 2000, and the first elastic member 363 provides an elastic allowance, thereby achieving a floating pressing by the first gripper driving member 310 and the first gripper onto the flowcell 2000, thus avoiding damage to the flowcell 2000.

In one embodiment, after the flowcell gripping mechanism 300 places the flowcell 2000 onto the station 10, the flowcell 2000 is adsorbed onto the station 10 by means of vacuum adsorption. For example, the station 10 is provided with an adsorption platform, and the adsorption platform is in communication with a vacuum pump. After the flowcell 2000 is placed on the adsorption platform, the vacuum pump extracts the air from the adsorption platform so that the flowcell 2000 is adsorbed onto the adsorption platform. The arrangement of the first connecting block 361, the first pressing plate 362, and the first clastic member 363 arranged between the first connecting block 361 and the first pressing plate 362 achieves the floating pressing of the flowcell 2000 by the first gripper driving member 310 and the first gripper. This ensures that the flowcell 2000 is not damaged, while further facilitating the successful gripping of the flowcell 2000 by the first gripper.

In some specific embodiments of the present disclosure, referring to FIGS. 13, 15, and 16, the flowcell gripping mechanism 300 further includes a fourth guide rail 371 arranged on the mounting base 330 and a fourth guide block 372 arranged on the fourth guide rail 371. The first connecting block 361 is arranged between the first gripper driving member 310 and the fourth guide block 372.

The direction in which the fourth guide rail 371 is arranged is the same as the floating direction of the first elastic member 363. After the first gripper driving member 310 drives the first gripper to contact the flowcell 2000, the first clastic member 363 provides an clastic allowance, and the first gripper driving member 310 moves in a direction away from the flowcell 2000. The first gripper driving member 310, via the first connecting block 361, drives the fourth guide block 372 to move on the fourth guide rail 371. The fourth guide block 372 cooperates with the fourth guide rail 371 to provide a guiding effect for the first gripper driving member 310, thereby ensuring the movement accuracy of the first gripper driving member 310. In addition, the arrangement of the fourth guide block 372 and the fourth guide rail 371 can ensure that the first gripper driving member 310, the first gripper, and the first connecting block 361 float, such as floating up and down. Moreover, since the fourth guide rail 371 is arranged on the mounting base 330, the fourth guide rail 371, via the fourth guide block 372, can provide better support for the first gripper driving member 310, the first gripper, and the first connecting block 361.

In some specific embodiments of the present disclosure, referring to FIGS. 13, 15, and 16, the flowcell gripping mechanism 300 further includes a second connecting block 381, a second pressing plate 382, and a second elastic member 383. The second connecting block 381 is arranged on the second gripper driving member 340, the second pressing plate 382 is arranged on the mounting base 330, and the second elastic member 383 is arranged between the second connecting block 381 and the second pressing plate 382.

The second clastic member 383 may include, but is not limited to, a spring, a resilient sheet, a rubber ring, or a rubber sheet.

The multi-axis mechanical arm 200 drives the mounting base 330 to move, such as moving downward, and the mounting base 330 simultaneously drives the second gripper driving member 340, the second connecting block 381, the second pressing plate 382, and the second clastic member 383 to move, such as moving downward. During the movement, the second gripper driving member 340, the second connecting block 381, the second pressing plate 382, and the second clastic member 383 remain stationary with respect to each other. Then, the second gripper driving member 340 drives the second gripper to contact the flowcell 2000, and the second elastic member 383573 provides an elastic allowance, thereby achieving a floating pressing by the second gripper driving member 340 and the second gripper onto the flowcell 2000, thus avoiding damage to the flowcell 2000.

In one embodiment, after the flowcell gripping mechanism 300 places the flowcell 2000 onto the station 10, the flowcell 2000 is adsorbed onto the station 10 by means of vacuum adsorption. For example, the station 10 is provided with an adsorption platform, and the adsorption platform is in communication with a vacuum pump. After the flowcell 2000 is placed on the adsorption platform, the vacuum pump extracts the air from the adsorption platform so that the flowcell 2000 is adsorbed onto the adsorption platform. The arrangement of the second connecting block 381, the second pressing plate 382, and the second elastic member 383 arranged between the second connecting block 381 and the second pressing plate 382 achieves the floating pressing of the flowcell 2000 by the second gripper driving member 340 and the second gripper. This ensures that the flowcell 2000 is not damaged, while further facilitating the successful gripping of the flowcell 2000 by the second gripper.

In some specific embodiments of the present disclosure, referring to FIGS. 13, 15, and 16, the flowcell gripping mechanism 300 further includes a fifth guide rail 391 arranged on the other side of the mounting base 330 and a fifth guide block 392 arranged on the fifth guide rail 391. The second connecting block 381 is arranged between the second gripper driving member 340 and the fifth guide block 392.

The direction in which the fifth guide rail 391 is arranged is the same as the floating direction of the second elastic member 383. After the second gripper driving member 340 drives the second gripper to contact the flowcell 2000, the second elastic member 383 provides an clastic allowance, and the second gripper driving member 340 moves in a direction away from the flowcell 2000. The second gripper driving member 340, via the second connecting block 381, drives the fifth guide block 392 to move on the fifth guide rail 391. The fifth guide block 392 cooperates with the fifth guide rail 391 to provide a guiding effect for the second gripper driving member 340, thereby ensuring the movement accuracy of the second gripper driving member 340. In addition, the arrangement of the fifth guide block 392 and the fifth guide rail 391 can ensure that the second gripper driving member 340, the second gripper, and the second connecting block 381 float, such as floating up and down. Moreover, since the fifth guide rail 391 is arranged on the mounting base 330, the fifth guide rail 391, via the fifth guide block 392, can provide better support for the second gripper driving member 340, the second gripper, and the second connecting block 381.

Referring to FIGS. 13, 19, and 20, a station layout device provided according to the embodiments of the present disclosure cooperates with the flowcell transfer device 1000 according to any one of the above embodiments. The station layout device includes at least one first station platform, and the first station platform is provided with at least one biochemical station 12, at least one imaging station 11, at least one loading station 13, and at least one cleaning station 15. The station layout device further includes at least one second station platform or a bin, and the second station platform or the bin is provided with at least one recycling station 14.

One first station platform may be provided, and at least one biochemical station 12, at least one imaging station 11, at least one loading station 13, and at least one cleaning station 15 are all arranged on the first station platform.

A plurality of first station platforms may be provided. The number of first station platforms is consistent with the total number of biochemical stations 12, imaging stations 11, loading stations 13, and cleaning stations 15, and at least one biochemical station 12, at least one imaging station 11, at least one loading station 13, and at least one cleaning station 15 are respectively arranged on the first station platforms. Alternatively, a plurality of first station platforms may be provided. The number of first station platforms is not consistent with the total number of biochemical stations 12, imaging stations 11, loading stations 13, and cleaning stations 15; some of the plurality of stations 10 are arranged on a single first station platform, and some of the individual stations 10 are arranged on a single first station platform.

The recycling station 14 may be arranged on the second station platform. One second station platform may be provided, and at least one recycling station 14 is arranged on the second station platform. A plurality of second station platforms may be provided, and the number of second station platforms is consistent with the number of recycling stations 14, with the plurality of recycling stations 14 respectively arranged on the second station platforms. Alternatively, a plurality of second station platforms may be provided, and the number of second station platforms is not consistent with the number of recycling stations 14, where at least one recycling station 14 is arranged on a single second station platform.

The recycling station 14 may be arranged on the bin. One bin may be provided, and the recycling station 14 is arranged on the bin. By arranging the recycling station 14 on the bin, the flowcell gripping mechanism 300 can grip an old flowcell 2000, move the flowcell above the bin, and then release the old flowcell 2000, discarding the old flowcell 2000 into the bin.

The first station platform may include a first contact platform 410 and a first support leg 420 arranged below the first contact platform 410. The first contact platform 410 is provided with a first platform surface 411, and the first platform surface 411 is configured for the placement of the flowcell 2000; the first support leg 420 provides support for the first contact platform 410 and can raise the first contact platform 410 so that when the flowcell transfer device 1000 needs to grip or place the flowcell 2000 on the first contact platform 410, the travel distance can be effectively shortened. Alternatively, the first station platform is provided only with the first contact platform 410; the first contact platform 410 is provided with a first platform surface 411, and the first platform surface 411 is configured for the placement of the flowcell 2000.

The second station platform may include a second contact platform and a second support leg arranged below the second contact platform. The second contact platform is provided with a second platform surface, and the second platform surface is configured for the placement of the flowcell 2000; the second support leg provides support for the second contact platform and can raise the second contact platform so that when the flowcell transfer device 1000 needs to grip or place the flowcell 2000 on the second contact platform, the travel distance can be effectively shortened. Alternatively, the second station platform is provided only with the second contact platform; the second contact platform is provided with a second platform surface, and the second platform surface is configured for the placement of the flowcell 2000.

The bin may include a cavity, and when the flowcell gripping mechanism 300 discards an old flowcell 2000, the old flowcell 2000 can fall into the cavity.

The first station platform and the second station platform may be station platforms that are arranged independently of each other, or may be integrated as a single station platform.

In this embodiment, a plurality of flowcells 2000 may be placed at the loading station 13, for example, three flowcells 2000 are placed at the loading station 13, and a cleaning flowcell 2000 may be placed at the cleaning station 15. The flowcell gripping mechanism 300 grips a first flowcell 2000 at the loading station 13 and places the first flowcell at the biochemical station 12, where the first flowcell 2000 undergoes a biochemical reaction at the biochemical station 12.

After the biochemical reaction is completed, the flowcell gripping mechanism 300 then grips the first flowcell 2000 at the biochemical station 12 and places the first flowcell at the imaging station 11, where the first flowcell 2000 undergoes sequencing imaging at the imaging station 11. The flowcell gripping mechanism 300 then grips a cleaning flowcell 2000 at the cleaning station 15 and places the cleaning flowcell at the biochemical station 12 to clean the components of the biochemical station 12, such as a liquid inlet/outlet. After cleaning is completed, the flowcell gripping mechanism 300 then grips the cleaning flowcell 2000 at the biochemical station 12 and places the cleaning flowcell at the cleaning station 15. The flowcell gripping mechanism 300 then grips a second flowcell 2000 at the loading station 13 and places the second flowcell at the biochemical station 12, where the second flowcell 2000 undergoes a biochemical reaction at the biochemical station 12. Alternatively, without cleaning the biochemical station 12, the flowcell gripping mechanism 300 grips the second flowcell 2000 at the loading station 13 and places the second flowcell at the biochemical station 12, where the second flowcell 2000 undergoes a biochemical reaction at the biochemical station 12. When the sequencing imaging on the first flowcell 2000 at the imaging station 11 is completed, the flowcell gripping mechanism 300 then grips the first flowcell 2000 at the imaging station 11 and places the first flowcell at the recycling station 14. When the second flowcell 2000 at the biochemical station 12 completes the biochemical reaction, the flowcell gripping mechanism 300 then grips the second flowcell 2000 at the biochemical station 12 and places the second flowcell at the imaging station 11, where the second flowcell 2000 undergoes sequencing imaging at the imaging station 11. The flowcell gripping mechanism 300 then grips the cleaning flowcell 2000 at the cleaning station 15 and places the cleaning flowcell at the biochemical station 12. After cleaning is completed, the flowcell gripping mechanism 300 then grips the cleaning flowcell 2000 at the biochemical station 12 and places the cleaning flowcell at the cleaning station 15. The flowcell gripping mechanism 300 then grips a third flowcell 2000 at the loading station 13 and places the third flowcell at the biochemical station 12, where the third flowcell 2000 undergoes a biochemical reaction at the biochemical station 12. Alternatively, without cleaning the biochemical station 12, the flowcell gripping mechanism 300 grips the third flowcell 2000 at the loading station 13 and places the third flowcell at the biochemical station 12, where the third flowcell 2000 undergoes a biochemical reaction at the biochemical station 12. When the sequencing imaging on the second flowcell 2000 at the imaging station 11 is completed, the flowcell gripping mechanism 300 then grips the second flowcell 2000 at the imaging station 11 and places the second flowcell at the recycling station 14. When the third flowcell 2000 at the biochemical station 12 completes the biochemical reaction, the flowcell gripping mechanism 300 then grips the third flowcell 2000 at the biochemical station 12 and places the third flowcell at the imaging station 11. When the sequencing imaging on the third flowcell 2000 at the imaging station 11 is completed, the flowcell gripping mechanism 300 then grips the third flowcell 2000 at the imaging station 11 and places the third flowcell at the recycling station 14. During the sequencing of the plurality of flowcells 2000, the flowcell gripping mechanism 300 transfers flowcells 2000 among different stations 10, enabling orderly transfer of each flowcell 2000. Duc to the arrangement of multiple stations 10, the simultaneous operation of multiple flowcells 2000 at multiple stations 10 can be achieved, for example, one of the flowcells 2000 is undergoing a biochemical reaction while another flowcell 2000 is simultaneously undergoing sequencing imaging, thereby effectively improving sequencing efficiency.

After the flowcell 2000 completes one cycle—completing the biochemical reaction at the biochemical station 12 and then transferring to the imaging station 11 for sequencing imaging—there may be a situation where the entire sequencing is not yet finished, for example, only sequencing for cycles 1-10 has been performed, and sequencing for cycles 11-20 is still required. The flowcell gripping mechanism 300 needs to grip the cleaning flowcell 2000 from the cleaning station 15 and transfer the cleaning flowcell to the biochemical station 12 for cleaning. After that, the flowcell 2000 is transferred from the imaging station 11 to the biochemical station 12. Alternatively, without cleaning the biochemical station 12, the flowcell 2000 is transferred from the imaging station 11 to the biochemical station 12, followed by a biochemical reaction. After the biochemical reaction is completed, the flowcell is again transferred to the imaging station 11 for sequencing imaging. After the flowcell 2000 completes the entire sequencing, the flowcell gripping mechanism 300 then transfers the flowcell 2000 from the imaging station 11 to the recycling station 14. Further, after the flowcell 2000 is transferred from the biochemical station 12 to the imaging station 11 for the last time, the flowcell gripping mechanism 300 grips the cleaning flowcell 2000 from the cleaning station 15 and transfers the cleaning flowcell to the biochemical station 12 for cleaning, and grips the next flowcell 2000 from the loading station 13 and transfers the flowcell to the biochemical station.

Furthermore, a plurality of biochemical stations 12 may be arranged, allowing a plurality of flowcells 2000 to undergo biochemical reactions at their respective biochemical stations 12. As a specific implementation, for a flowcell 2000 that requires a biochemical reaction, when a biochemical station 12 is in an idle state (no flowcell 2000 is undergoing a biochemical reaction at the biochemical station 12), and if the biochemical station 12 has not previously performed a biochemical reaction, the flowcell gripping mechanism 300 transfers the flowcell 2000 that requires a biochemical reaction to the idle biochemical station 12 for the biochemical reaction. If the biochemical station 12 has previously performed a biochemical reaction, the flowcell gripping mechanism 300 transfers a cleaning flowcell 2000 from the cleaning station 15 to the biochemical station 12 for cleaning. After the cleaning is completed, the flowcell 2000 that requires a biochemical reaction is transferred to the biochemical station 12 for the biochemical reaction. Alternatively, without cleaning the biochemical station 12, the flowcell 2000 that requires a biochemical reaction is transferred to the biochemical station 12 to undergo the biochemical reaction. A plurality of imaging stations 11 may be arranged, allowing a plurality of flowcells 2000 to undergo sequencing imaging at their respective imaging stations 11. As a specific implementation, for a flowcell 2000 that requires sequencing imaging, when an imaging station 11 is in an idle state (no flowcell 2000 is undergoing sequencing imaging at the imaging station 11), the flowcell gripping mechanism 300 transfers the flowcell 2000 that requires sequencing imaging to the idle imaging station 11 for sequencing imaging. A plurality of cleaning flowcells 2000 may be placed on the cleaning station 15. Alternatively, a plurality of cleaning stations 15 may be arranged, and one cleaning flowcell 2000 is placed on each cleaning station 15, thereby facilitating the flowcell gripping mechanism 300 in transferring each cleaning flowcell 2000 to the biochemical station 12 that requires cleaning. As a specific implementation, for a biochemical station 12 that requires cleaning, when there is a cleaning flowcell 2000 at the cleaning station 15, the flowcell gripping mechanism 300 transfers the cleaning flowcell 2000 to the biochemical station 12 that requires cleaning, so as to clean the biochemical station 12. According to the above implementation, the arrangement of more biochemical stations 12, more imaging stations 11, and/or more cleaning flowcells 2000 can achieve more simultaneous sequencing processes, such as multiple biochemical reaction processes, multiple sequencing imaging processes, and/or multiple cleaning processes, thereby further improving sequencing efficiency.

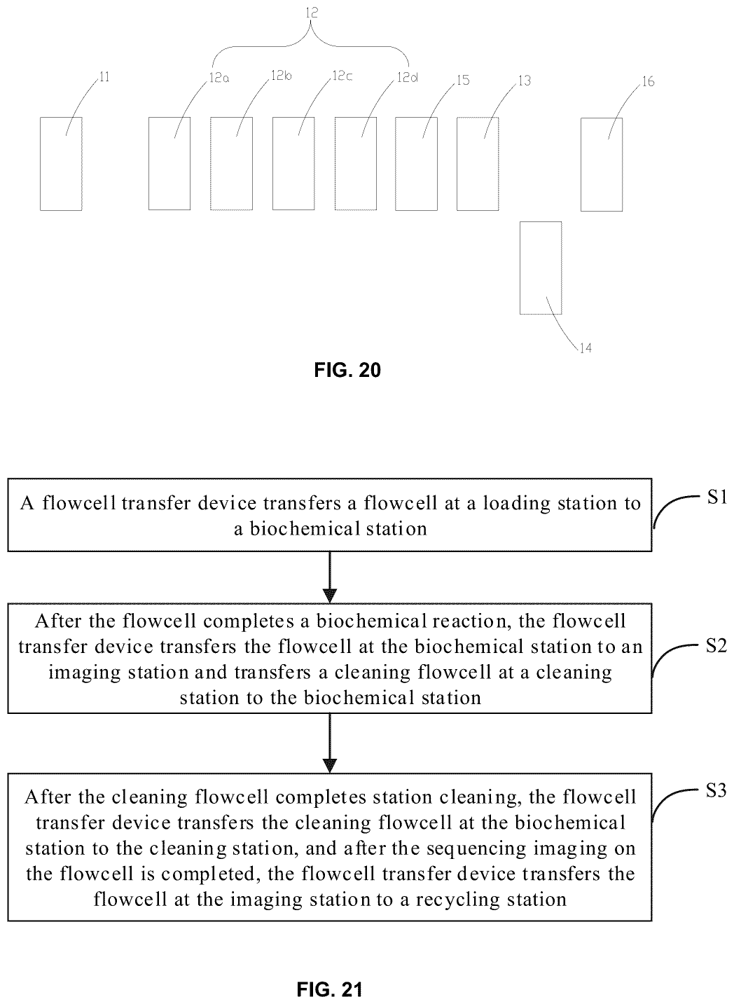

In some specific embodiments of the present disclosure, referring to FIG. 20, a plurality of biochemical stations 12 are provided, and each biochemical station 12 and the imaging station 11 are sequentially arranged along a first straight line from left to right or from right to left.

By arranging a plurality of biochemical stations 12, when a flowcell 2000 at a biochemical station 12 completes the biochemical reaction and the imaging station 11 is in an idle state, the flowcell 2000 can be transferred to the imaging station 11, such that the next flowcell 2000 at the loading station 13 can be transferred to the biochemical station 12. This arrangement can satisfy the requirement of simultaneous biochemical reactions for a plurality of flowcells 2000, thereby making full use of each station 10 to avoid resource waste and effectively improve efficiency.

Exemplarily, four biochemical stations 12 are provided, and one imaging station 11 is provided. The four biochemical stations 12 and the one imaging station 11 are arranged in the first straight line. The four biochemical stations 12 are sequentially arranged from left to right and are respectively biochemical stations 12a, 12b, 12c, and 12d. The one imaging station 11 is located on one side of the biochemical station 12a. The flowcell gripping mechanism 300 first sequentially transfers the four flowcells 2000 located at the loading station 13 to the biochemical stations 12a, 12b, 12c, and 12d. After the flowcell 2000 at the biochemical station 12a completes the biochemical reaction, the flowcell 2000 at the biochemical station 12a is transferred to the imaging station 11, with the biochemical station 12a being in an idle state. After the sequencing imaging on the flowcell 2000 at the imaging station 11 is completed, the flowcell 2000 at the imaging station 11 is transferred to the recycling station 14. After the flowcell 2000 at the biochemical station 12b completes the biochemical reaction, the flowcell 2000 at the biochemical station 12b is transferred to the imaging station 11, with the biochemical station 12b being in an idle state. After the sequencing imaging on the flowcell 2000 at the imaging station 11 is completed, the flowcell 2000 at the imaging station 11 is transferred to the recycling station 14. After the flowcell 2000 at the biochemical station 12c completes the biochemical reaction, the flowcell 2000 at the biochemical station 12c is transferred to the imaging station 11, with the biochemical station 12c being in an idle state. After the sequencing imaging on the flowcell 2000 at the imaging station 11 is completed, the flowcell 2000 at the imaging station 11 is transferred to the recycling station 14. After the flowcell 2000 at the biochemical station 12d completes the biochemical reaction, the flowcell 2000 at the biochemical station 12d is transferred to the imaging station 11, with the biochemical station 12d being in an idle state. After the sequencing imaging on the flowcell 2000 at the imaging station 11 is completed, the flowcell 2000 at the imaging station 11 is transferred to the recycling station 14. Ultimately, the sequencing of all flowcells 2000 is completed. In this process, each station 10 can be fully utilized to avoid resource waste and effectively improve efficiency. If, after the sequencing imaging on the flowcell 2000 at the imaging station 11 is completed, the flowcell 2000 has not yet completed the entire sequencing, and one biochemical station 12 among the biochemical stations 12a, 12b, 12c, and 12d is in an idle state, then after cleaning, the flowcell 2000 at the imaging station 11 is transferred to the biochemical station 12 to continue the biochemical reaction, and after the biochemical reaction is completed, the flowcell is transferred again to the imaging station 11 for sequencing imaging. Alternatively, without cleaning the biochemical station 12, the flowcell 2000 at the imaging station 11 is transferred to the biochemical station 12 to continue the biochemical reaction, and after the biochemical reaction is completed, the flowcell is again transferred to the imaging station 11 to perform sequencing imaging. If, after the sequencing imaging on the flowcell 2000 at the imaging station 11 is completed, the flowcell 2000 has completed the entire sequencing, then the flowcell gripping mechanism 300 transfers the flowcell 2000 from imaging station 11 to the recycling station 14.

Since typically, the flowcell 2000 needs to undergo sequencing imaging after the biochemical reaction, arranging the biochemical station 12 and the imaging station 11 in a first straight line can effectively shorten the movement path of the flowcell gripping mechanism 300. In addition, with the imaging station 11 arranged at the edge-most position of the first straight line, compared with the imaging station 11 being arranged at the middle position of the first straight line, it is possible to avoid the situation in which the flowcell gripping mechanism 300 needs to move to the biochemical station 12 at the edge-most position to grip the flowcell 2000 and then move to the imaging station 11 at the middle position to place the flowcell 2000. This can further shorten the movement path of the flowcell gripping mechanism 300 and facilitate the layout of the biochemical system for the biochemical reaction of the flowcell 2000 and the imaging system for sequencing imaging of the flowcell 2000. In summary, the biochemical station 12 and the imaging station 11 are arranged in a first straight line, and the imaging station 11 is arranged at the edge-most position of the first straight line, making the station 10 layout more reasonable. This can not only shorten the movement path of the flowcell gripping mechanism 300 and save transfer time for the flowcell 2000, but also facilitate the layout of surrounding systems, such as the biochemical system and the imaging system.

In some specific embodiments of the present disclosure, referring to FIG. 20, the cleaning station 15 and the loading station 13 are arranged on the first straight line; the imaging station 11 is arranged on one side of the biochemical station 12, and the cleaning station 15 and the loading station 13 are arranged on the other side of the biochemical station 12.

By arranging the imaging station 11, the biochemical station 12, the cleaning station 15, and the loading station 13 on the first straight line, when the flowcell gripping mechanism 300 transfers a flowcell 2000 among the imaging station 11, the biochemical station 12, the cleaning station 15, and the loading station 13, the flowcell gripping mechanism only needs to reciprocate along the same straight line, thereby facilitating the movement of the flowcell gripping mechanism 300 driven by the multi-axis mechanical arm 200. In addition, this can also prevent the multi-axis mechanical arm 200 from needing to drive the flowcell gripping mechanism 300 to move into a movement blind zone. For example, taking the multi-axis mechanical arm 200 as the dividing line, one side away from the station 10 is the movement blind zone, and the multi-axis mechanical arm 200 cannot drive the flowcell gripping mechanism 300 to move into the movement blind zone. The cleaning flowcell 2000 transferred from the cleaning station 15 usually needs to be transferred to the biochemical station 12, and the flowcell 2000 transferred from the loading station 13 also usually needs to be transferred to the biochemical station 12. Therefore, the cleaning station 15 and the loading station 13 are arranged on one side of the biochemical station 12, and this side is away from the imaging station 11, so as to avoid the need for the flowcell gripping mechanism 300 to pass through the imaging station 11 when transferring flowcells 2000 from the cleaning station 15 and loading station 13, thereby reducing the movement path of the flowcell gripping mechanism 300 and improving the transfer efficiency of the flowcell 2000.

Furthermore, the cleaning station 15 is located closer to the biochemical station 12 than the loading station 13. The flowcell gripping mechanism 300 transfers the cleaning flowcell 2000 from the cleaning station 15 to the biochemical station 12, and usually, after the cleaning is completed, the cleaning flowcell 2000 needs to be transferred from the biochemical station 12 to the cleaning station 15; this involves a reciprocating movement process. In contrast, when the flowcell gripping mechanism 300 transfers the flowcell 2000 from the loading station 13 to the biochemical station 12, it usually does not require transferring the flowcell 2000 from the biochemical station 12 to the loading station 13; this is only a one-way movement process. Therefore, by arranging the cleaning station 15 closer to the biochemical station 12 than the loading station 13, the movement path of the flowcell gripping mechanism 300 can be further reduced, thereby improving the transfer efficiency of the flowcell 2000.

In some specific embodiments of the present disclosure, referring to FIG. 20, the first station platform is further provided with at least one emergency station 16.

By arranging the emergency station 16, in the event of a special situation, such as when a flowcell 2000 undergoing a biochemical reaction at the biochemical station 12 encounters a problem and the biochemical reaction cannot proceed smoothly, the flowcell gripping mechanism 300 can transfer the flowcell 2000 from the biochemical station 12 to the emergency station 16. After troubleshooting, the flowcell gripping mechanism 300 can then transfer the flowcell 2000 from the emergency station 16 to the biochemical station 12. Alternatively, the biochemical station 12 is abandoned first, and after the batch of flowcells 2000 has completed sequencing, troubleshooting is then performed on the biochemical station 12.

In some specific embodiments of the present disclosure, referring to FIG. 20, the emergency station 16 is arranged on the first straight line, and the emergency station 16 is arranged at the edge-most position of the first straight line away from the imaging station 11.

In this embodiment, since the emergency station 16 is used in relatively few situations, the emergency station 16 is farther from the biochemical station 12 and the imaging station 11 than the cleaning station 15 and the loading station 13. It can be understood that the emergency station 16 is located at the corner position among all the stations 10. Such an arrangement facilitates the flowcell gripping mechanism 300 in gripping and placing the cleaning flowcell 2000 at the cleaning station 15, as well as gripping the flowcell 2000 at the loading station 13, and can further shorten the movement path of the flowcell gripping mechanism 300.

In some specific embodiments of the present disclosure, referring to FIG. 20, the recycling station 14 is arranged at a position near the compartment door of the sequencing system.

It should be noted that although the frame 100 shown in FIG. 13 is open on all sides, in actual scenarios, the frame 100 is provided with an enclosure to prevent the external environment from affecting the internal environment. Exemplarily, an automatically or manually openable compartment door is provided on the enclosure. After the compartment door is opened, an old flowcell 2000 can be collected at the recycling station 14. Therefore, arranging the recycling station 14 near the compartment door is conducive to the operation of recycling flowcells 2000. Furthermore, the loading station 13 is arranged at a position near the recycling station 14. After the compartment door is opened, a new flowcell 2000 can be added at the loading station 13. Therefore, arranging the loading station 13 near the recycling station 14 is conducive to the operation of adding flowcells 2000.

For ease of understanding, the reference numerals for the components of the sequencing system and flowcell transfer method described below are based on the flowcell transfer device 1000 and the station layout device shown in FIGS. 1 to 12. However, it can be understood that the sequencing system and flowcell transfer method described below can also be applied to the flowcell transfer device 1000 and the station layout device shown in FIGS. 13 to 20.

The embodiments of the present disclosure provide a sequencing system. The sequencing system includes the flowcell transfer device 1000 according to any one of the above embodiments, a fluidic mechanism, and an optical mechanism.

The flowcell transfer device 1000 transfers the flowcell 2000 at the loading station 13 to the biochemical station 12, and the fluidic mechanism introduces a biochemical reagent into the flowcell 2000 to enable the flowcell 2000 to complete the biochemical reaction. The flowcell transfer device 1000 then transfers the flowcell 2000 at the biochemical station 12 to the imaging station 11, the optical mechanism performs sequencing imaging on the flowcell 2000 and transfers the cleaning flowcell 2000 at the cleaning station 15 to the biochemical station 12, and the fluidic mechanism introduces a cleaning reagent into the cleaning flowcell 2000. After the sequencing imaging on the flowcell 2000 is completed, the flowcell transfer device 1000 transfers the flowcell 2000 at the imaging station 11 to the recycling station 14, and after the cleaning flowcell 2000 completes the station cleaning, the flowcell transfer device 1000 transfers the cleaning flowcell 2000 at the biochemical station 12 to the cleaning station 15.

In some embodiments, the sequencing system includes the station layout device according to any one of the above embodiments.

The sequencing system may be a sequencer. The sequencer includes a control device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. Alternatively, the sequencing system may be an integrated system combining a sequencer and a server. The sequencer includes a control device, a communication device, a fluidic mechanism, and an optical mechanism. Under the control of the control device, the fluidic mechanism can introduce a DNA or RNA sample and a biochemical reagent into the flowcell 2000; or, if the DNA or RNA sample is already present in the flowcell 2000, the fluidic mechanism only needs to introduce the biochemical reagent into the flowcell 2000. The optical mechanism can photograph and image the flowcell 2000. The control device performs sequencing based on the obtained image to generate a sequencing result. The control device then controls the communication device to send the sequencing data to the server, and the server stores and/or processes the sequencing data.

In the flowcell transfer device 1000 provided according to the embodiments of the present disclosure, under the motion of the multi-dimensional motion mechanism, the flowcell gripping mechanism 500 can be driven to move in multiple dimensions, thereby achieving multi-dimensional motion of the flowcell gripping mechanism 500. The flowcell gripping mechanism 500 is capable of gripping a flowcell 2000 at any station 10 and placing the flowcell 2000 at any other station 10, thereby achieving sequencing of multiple flowcells 2000 at multiple stations 10 and effectively improving sequencing efficiency.

In the station layout device provided according to the embodiments of the present disclosure, the station layout device cooperates with the flowcell transfer device 1000. During the sequencing of the plurality of flowcells 2000, the flowcell gripping mechanism 500 transfers flowcells 2000 among different stations 10, enabling orderly transfer of each flowcell 2000. Due to the arrangement of multiple stations 10, the simultaneous operation of multiple flowcells 2000 and multiple stations 10 can be achieved, for example, one of the flowcells 2000 is undergoing a biochemical reaction while another flowcell 2000 is simultaneously undergoing sequencing imaging, thereby effectively improving sequencing efficiency.

Referring to FIG. 21, a flowcell transfer method provided according to the embodiments of the present disclosure is applied to the flowcell transfer device according to any one of the above embodiments. The flowcell transfer method includes the following steps: S1. The flowcell transfer device transfers a flowcell at a loading station to a biochemical station. S2. After the flowcell completes a biochemical reaction, the flowcell transfer device transfers the flowcell at the biochemical station to an imaging station, and transfers a cleaning flowcell at a cleaning station to the biochemical station. S3. After the cleaning flowcell completes the station cleaning, the flowcell transfer device transfers the cleaning flowcell at the biochemical station to the cleaning station, and after the sequencing imaging on the flowcell is completed, the flowcell transfer device transfers the flowcell at the imaging station to a recycling station.

In this embodiment, after the flowcell 2000 is placed at the loading station 13 and the cleaning flowcell 2000 is placed at the cleaning station 15, the flowcell transfer device 1000 transfers the flowcell 2000 at the loading station 13 to the biochemical station 12, where the flowcell 2000 undergoes a biochemical reaction at the biochemical station 12. After the biochemical reaction is completed, the flowcell transfer device 1000 transfers the flowcell 2000 at the biochemical station 12 to the imaging station 11, where the flowcell 2000 undergoes sequencing imaging at the imaging station 11. At this point, the biochemical station 12 is in an idle state, and the flowcell transfer device 1000 transfers the cleaning flowcell 2000 at the cleaning station 15 to the biochemical station 12 to clean the components at the biochemical station 12, such as a liquid inlet/outlet. After the cleaning flowcell 2000 completes the station cleaning, the flowcell transfer device 1000 transfers the cleaning flowcell 2000 at the biochemical station 12 to the cleaning station 15. Moreover, after the sequencing imaging on the flowcell 2000 is completed, the flowcell transfer device 1000 transfers the flowcell 2000 at the imaging station 11 to the recycling station 14.

In some specific embodiments of the present disclosure, after the sequencing imaging on the flowcell is completed, the flowcell transfer device transfers the flowcell at the imaging station to the recycling station, which includes the following steps: S32. After the sequencing imaging on the flowcell is completed and the cleaning flowcell at the biochemical station has been transferred to the cleaning station, the flowcell transfer device transfers the flowcell at the imaging station to the biochemical station. S34. After the flowcell completes the biochemical reaction, the flowcell transfer device transfers the flowcell at the biochemical station to the imaging station and transfers the cleaning flowcell at the cleaning station to the biochemical station. S36. Steps S32 and S34 are repeated until the final cycle of sequencing imaging on the flowcell is completed, with the flowcell transfer device transferring the flowcell at the imaging station to the recycling station.

In this embodiment, after the flowcell 2000 completes one cycle—completing the biochemical reaction at the biochemical station 12 and then transferring to the imaging station 11 for sequencing imaging—there may be a situation where the entire sequencing is not yet finished, for example, only sequencing for cycles 1-10 has been performed, and sequencing for cycles 11-20 is still required. In this case, after the sequencing imaging on the flowcell 2000 is completed, the flowcell transfer device 1000 does not transfer the flowcell 2000 at the imaging station 11 to the recycling station 14. Instead, after confirming that the cleaning flowcell 2000 at the biochemical station 12 has been transferred to the cleaning station 15, the flowcell 2000 at the imaging station 11 is transferred to the biochemical station 12. The process of completing the biochemical reaction at the biochemical station 12 and sequencing imaging at the imaging station 11 is then repeated, and after each biochemical reaction at the biochemical station 12 is completed, the flowcell transfer device 1000 transfers the cleaning flowcell 2000 to the biochemical station 12 to clean the biochemical station 12. This is repeated until the flowcell 2000 completes the final cycle of sequencing imaging, with the flowcell transfer device 1000 transferring the flowcell 2000 at the imaging station 11 to the recycling station 14.

In some specific embodiments of the present disclosure, a plurality of flowcells 2000 are provided, or a plurality of flowcells 2000 are provided and a plurality of biochemical stations 12 are provided. The flowcell transfer method further includes the following steps: S42. When the biochemical station is in an idle state, the flowcell transfer device transfers the next flowcell at the loading station to the biochemical station. S44. After the next flowcell completes the biochemical reaction and the imaging station is in an idle state, the flowcell transfer device transfers the next flowcell at the biochemical station to the imaging station and transfers the cleaning flowcell at the cleaning station to the biochemical station. S46. After the sequencing imaging on the next flowcell is completed, the flowcell transfer device transfers the next flowcell at the imaging station to the recycling station. S48. Steps S42, S44, and S46 are repeated until all flowcells have been transferred to the recycling station.

A plurality of flowcells 2000 are provided, and one biochemical station 12 is provided. As an example that may be implemented, after the flowcell transfer device 1000 transfers the current flowcell 2000 from the biochemical station 12 to the imaging station 11, the biochemical station 12 is in an idle state. The flowcell transfer device 1000 then transfers the next flowcell 2000 at the loading station 13 to the biochemical station 12, such that the next flowcell 2000 can undergo a biochemical reaction at the biochemical station 12. After the flowcell transfer device 1000 transfers the current flowcell 2000 from the imaging station 11 to the recycling station 14, the imaging station 11 is in an idle state. Moreover, after the next flowcell 2000 completes the biochemical reaction, the flowcell transfer device 1000 transfers the next flowcell 2000 from the biochemical station 12 to the imaging station 11, such that the next flowcell 2000 undergoes sequencing imaging at the imaging station 11. At this point, the biochemical station 12 is in an idle state. The flowcell transfer device 1000 transfers the cleaning flowcell 2000 at the cleaning station 15 to the biochemical station 12 to clean the biochemical station 12. After the sequencing imaging on the next flowcell 2000 is completed, the flowcell transfer device 1000 transfers the next flowcell 2000 at the imaging station 11 to the recycling station 14. The above steps are repeated until all flowcells 2000 have been transferred to the recycling station 14.

Alternatively, a plurality of flowcells 2000 are provided, and a plurality of biochemical stations 12 are provided. As an example that may be implemented, after the flowcell transfer device 1000 transfers a flowcell 2000, such as a first flowcell 2000, from the biochemical station 12 to the imaging station 11, when there is a biochemical station 12 in an idle state, the flowcell transfer device 1000 transfers a flowcell 2000 at the loading station 13, such as a second flowcell 2000, to the biochemical station 12, such that the second flowcell 2000 undergoes the biochemical reaction at the biochemical station 12. In this case, since there are a plurality of biochemical stations 12, there still remains a biochemical station 12 in an idle state, and the flowcell transfer device 1000 transfers a flowcell 2000 at the loading station 13, such as a third flowcell 2000, to the biochemical station 12, such that the third flowcell 2000 undergoes the biochemical reaction at the biochemical station 12. After the flowcell transfer device 1000 transfers the first flowcell 2000 from the imaging station 11 to the recycling station 14, the imaging station 11 is in an idle state. Moreover, after the second flowcell 2000 completes the biochemical reaction, the flowcell transfer device 1000 transfers the second flowcell 2000 from the biochemical station 12 to the imaging station 11, such that the second flowcell 2000 undergoes sequencing imaging at the imaging station 11. After the sequencing imaging on the second flowcell 2000 is completed, the flowcell transfer device 1000 transfers the second flowcell 2000 from the imaging station 11 to the recycling station 14, and the imaging station 11 is in an idle state. If at this point the third flowcell 2000 completes the biochemical reaction, the flowcell transfer device 1000 transfers the third flowcell 2000 from the biochemical station 12 to the imaging station 11, such that the third flowcell 2000 undergoes sequencing imaging at the imaging station 11. After the sequencing imaging on the third flowcell 2000 is completed, the flowcell transfer device 1000 transfers the third flowcell 2000 from the imaging station 11 to the recycling station 14. If there are more flowcells 2000, such as a fourth flowcell 2000, a fifth flowcell 2000, etc., when the biochemical station 12 is in an idle state and has been cleaned, the flowcell transfer device 1000 transfers flowcell 2000 to the biochemical station 12. After the imaging station 11 is in an idle state, the flowcell transfer device 1000 transfers the flowcell 2000 that has completed the biochemical reaction to the imaging station 11. After the sequencing imaging on the flowcell 2000 is completed, the flowcell transfer device 1000 transfers the flowcell 2000 that has completed the sequencing imaging to the recycling station 14. This is repeated until all flowcells 2000 have been transferred to the recycling station 14.

Furthermore, if the flowcell 2000 at the imaging station 11 has completed sequencing imaging but has not yet completed the entire sequencing, the flowcell transfer device 1000 may, when there is a biochemical station 12 in an idle state and the biochemical station has been cleaned, transfer the flowcell 2000 from the imaging station 11 to the biochemical station 12, such that the flowcell 2000 continues to undergo a biochemical reaction. After the imaging station 11 is in an idle state and the flowcell 2000 has completed the biochemical reaction, the flowcell transfer device 1000 then transfers the flowcell 2000 from the biochemical station 12 to the imaging station 11. This is repeated until the flowcell 2000 completes the final cycle of sequencing imaging, with the flowcell transfer device 1000 transferring the flowcell 2000 at the imaging station 11 to the recycling station 14.

In some specific embodiments of the present disclosure, the flowcell gripping mechanism 500 is provided with two sets of gripping mechanisms. By means of the two sets of gripping mechanisms, it is possible to successively grip flowcells 2000 and/or cleaning flowcells 2000, and successively place flowcells 2000 and/or cleaning flowcells 2000.

One set of gripping mechanism among the two sets of gripping mechanisms may be arranged on one side of the mounting base 530 described in any one of the above embodiments, and includes a first gripper driving member 510, first grippers, a first connecting block 571, a first pressing plate 572, a first elastic member 573, a fourth guide rail 561, and a fourth guide block 562. The other set of gripping mechanism among the two sets of gripping mechanisms may be arranged on the other side of the mounting base 530, and includes a second gripper driving member 540, second grippers, a second connecting block 591, a second pressing plate 592, a second clastic member 593, a fifth guide rail 581, and a fifth guide block 582.

In this embodiment, by means of two sets of gripping mechanisms, it is possible to successively grip flowcells 2000 and/or cleaning flowcells 2000. After the flowcell transfer device 1000 moves, the two sets of gripping mechanisms can successively place flowcells 2000 and/or cleaning flowcells 2000, such that the movement path of the flowcell gripping mechanism 500 can be shortened, the time for gripping and placing flowcells 2000 and/or cleaning flowcells 2000 can be reduced, and efficiency can be greatly improved.

In some specific embodiments of the present disclosure, the flowcell transfer device 1000 further includes a rotation mechanism 600 arranged between the two sets of gripping mechanisms. After the two sets of gripping mechanisms have successively gripped flowcells 2000 and/or cleaning flowcells 2000, the rotation mechanism 600 can drive the two sets of gripping mechanisms to rotate, with the rotation mechanism 600 as the center of rotation, such that the positions of the flowcells 2000 and/or cleaning flowcells 2000 are exchanged.

The rotation mechanism 600 may be the same as the rotation mechanism 600 described in any one of the above embodiments, and includes a rotation driving member 610, a connecting seat 620, a driving gear 631, and a driven gear 632, or includes a rotation driving member 610, a connecting seat 620, a driving gear, and a driven gear 632.

In this embodiment, the rotation mechanism 600 can drive the two sets of gripping mechanisms to rotate, and the two sets of gripping mechanisms drive the gripped flowcells 2000 and/or cleaning flowcells 2000 to rotate, such that the two sets of gripping mechanisms are more flexible, can further shorten the movement path, reduce the time for gripping and placing flowcells 2000 and/or cleaning flowcells 2000, and greatly improve efficiency.

In the description of this specification, the description of the terms “one embodiment”, “some embodiments”, “schematic embodiments”, “examples”, “certain examples”, “specific examples”, or the like, means that the particular features, structures, materials, or characteristics described with reference to the embodiment or example are included in at least one embodiment or example of the present disclosure. In this specification, the schematic description of the above terms does not necessarily refer to the same embodiment or example. Moreover, the particular features, structures, materials, or characteristics described may be combined in any one or more embodiments or examples in any appropriate manner.

Although the embodiments of the present disclosure have been illustrated and described above, it will be appreciated that the aforementioned embodiments are exemplary and should not be construed as limiting the present disclosure, and that those of ordinary skill in the art can make changes, modifications, replacements, and variations to such embodiments, without departing from the scope of the present disclosure.

What is claimed is:

1. A flowcell transfer device, wherein the flowcell transfer device is used in a sequencing system, and the flowcell transfer device comprises:
a frame;
a multi-dimensional motion mechanism arranged on the frame; and
a flowcell gripping mechanism arranged on the multi-dimensional motion mechanism, wherein the multi-dimensional motion mechanism is capable of driving the flowcell gripping mechanism to move so as to achieve multi-dimensional motion, such that the flowcell gripping mechanism is capable of gripping a flowcell at any station and placing the flowcell at any other station;
wherein the flowcell gripping mechanism comprises:
a first gripper driving member arranged on the multi-dimensional motion mechanism; and
a first gripper connected to the first gripper driving member, wherein the first gripper comprises oppositely arranged first jaw and second jaw, and driven by the first gripper driving member, the first jaw and the second jaw move toward or away from each other to grip or place the flowcell.

2. The flowcell transfer device according to claim 1, wherein the multi-dimensional motion mechanism comprises:
a first direction motion mechanism arranged on the frame;
a second direction motion mechanism connected to the first direction motion mechanism; and
a third direction motion mechanism connected to the second direction motion mechanism, wherein the first gripper driving member is arranged on the third direction motion mechanism.

3. The flowcell transfer device according to claim 2, wherein the first direction motion mechanism comprises:
a first driving member arranged on the frame;
a synchronous belt assembly connected to the first driving member; and
a moving plate moved by the synchronous belt assembly, wherein the second direction motion mechanism is arranged on the moving plate.

4. The flowcell transfer device according to claim 3, wherein the first direction motion mechanism further comprises first guide rails fixedly arranged on opposite sides of the frame and first guide blocks arranged on the first guide rails; one end of the moving plate is connected to the first guide block on one side of the frame, and the other end is connected to the first guide block on the other side of the frame.

5. The flowcell transfer device according to claim 2, wherein the second direction motion mechanism comprises:
a second driving member connected to the first direction motion mechanism; and
a first connecting assembly connected to the second driving member, wherein the third direction motion mechanism is arranged on the first connecting assembly.

6. The flowcell transfer device according to claim 5, wherein the first connecting assembly comprises:
a first connecting plate arranged on the first direction motion mechanism and connected to the second driving member; and
a fixing plate arranged on the first direction motion mechanism and fixedly connected to the first connecting plate, wherein the third direction motion mechanism is arranged on the fixing plate.

7. The flowcell transfer device according to claim 2, wherein the third direction motion mechanism comprises:
a third driving member connected to the second direction motion mechanism; and
a second connecting assembly connected to the third driving member, wherein the flowcell gripping mechanism is arranged on the second connecting assembly.

8. The flowcell transfer device according to claim 7, wherein the second connecting assembly comprises:
a second connecting plate connected to the third driving member; and
a movable seat fixedly connected to the second connecting plate, wherein the flowcell gripping mechanism is arranged on the movable seat.

9. The flowcell transfer device according to claim 2, further comprising a rotation mechanism connected to the third direction motion mechanism, wherein the flowcell gripping mechanism is arranged on the rotation mechanism.

10. The flowcell transfer device according to claim 9, wherein the rotation mechanism comprises:
a rotation driving member connected to the third direction motion mechanism; and
a connecting seat connected to the rotation driving member, wherein the flowcell gripping mechanism is arranged on the connecting seat.

11. The flowcell transfer device according to claim 1, wherein the multi-dimensional motion mechanism is a multi-axis mechanical arm, and the first gripper driving member is arranged on the multi-axis mechanical arm.

12. The flowcell transfer device according to claim 1, wherein both the first jaw and the second jaw are provided with a first positioning pin; when the first jaw and the second jaw move toward or away from each other, the first positioning pin contacts or moves away from a positioning groove of the flowcell.

13. The flowcell transfer device according to claim 1, wherein the flowcell gripping mechanism further comprises:
a mounting base arranged on the multi-dimensional motion mechanism, wherein the first gripper driving member is arranged on the mounting base;
a second gripper driving member arranged on the mounting base; and
a second gripper connected to the second gripper driving member, wherein the second gripper comprises oppositely arranged third jaw and fourth jaw, and driven by the second gripper driving member, the third jaw and the fourth jaw move toward or away from each other to grip or place the flowcell.

14. The flowcell transfer device according to claim 13, wherein the flowcell gripping mechanism further comprises:
a first connecting block arranged on the first gripper driving member;
a first pressing plate arranged on the mounting base; and
a first elastic member arranged between the first connecting block and the first pressing plate.

15. The flowcell transfer device according to claim 13, wherein the flowcell gripping mechanism further comprises:
a second connecting block arranged on the second gripper driving member;
a second pressing plate arranged on the mounting base; and
a second elastic member arranged between the second connecting block and the second pressing plate.

16. A station layout device, wherein the station layout device cooperates with the flowcell transfer device claim 1, and the station layout device comprises at least one first station platform, the first station platform being provided with at least one biochemical station, at least one imaging station, at least one loading station, and at least one cleaning station; the station layout device further comprises at least one second station platform or a bin, the second station platform or the bin being provided with at least one recycling station.

17. The station layout device according to claim 16, wherein a plurality of the biochemical stations are provided, and each of the biochemical stations and the imaging station are sequentially arranged along a first straight line from left to right or from right to left.

18. The station layout device according to claim 17, wherein the first station platform is further provided with at least one emergency station;
the loading station and the recycling station are arranged in a second straight line, and the cleaning station and the emergency station are arranged in a third straight line, the second straight line and the third straight line being respectively located on both sides of the first straight line; additionally, the loading station and the recycling station are arranged at positions near a compartment door of the sequencing system; and
the cleaning station and the loading station are arranged on the first straight line; the imaging station is arranged on one side of the biochemical station, and the cleaning station and the loading station are arranged on the other side of the biochemical station.

19. The station layout device according to claim 17, wherein the first station platform is further provided with at least one emergency station;
the emergency station is arranged on the first straight line, and the emergency station is arranged at an edge-most position of the first straight line away from the imaging station; and
the recycling station is arranged at a position near a compartment door of the sequencing system.

20. A sequencing system, comprising the flowcell transfer device according to claim 1, a fluidic mechanism, and an optical mechanism,
wherein the flowcell transfer device transfers a flowcell at a loading station to a biochemical station, and the fluidic mechanism introduces a biochemical reagent into the flowcell to enable the flowcell to complete a biochemical reaction; the flowcell transfer device then transfers the flowcell at the biochemical station to an imaging station, the optical mechanism performs sequencing imaging on the flowcell and transfers a cleaning flowcell at a cleaning station to the biochemical station, and the fluidic mechanism introduces a cleaning reagent into the cleaning flowcell; after the sequencing imaging on the flowcell is completed, the flowcell transfer device transfers the flowcell at the imaging station to a recycling station, and after the cleaning flowcell completes station cleaning, the flowcell transfer device transfers the cleaning flowcell at the biochemical station to the cleaning station.
